(19) United States
(12) Patent Application Publication
(10) Pub. No.: US 2001/0054035 A1
(43) Pub. Date: Dec. 20, 2001

(54) System and method for searching target web site by employing internet portal site having icons arranged according to frequency number of use

(76) Inventor: Soo Sung Lee, Seoul (KR)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 09/767,081

(22) Filed: Jan. 22, 2001

(30) Foreign Application Priority Data
Apr. 1, 2000 (KR) 2000-17135
May 17, 2000 (KR) 2000-26492
Jul. 6, 2000 (KR) 2000-38554
Dec. 4, 2000 (KR) 2000-72831

(51) Int. Cl. G06F 7/00

(52) U.S. Cl. 707/3

(57) ABSTRACT

A method for searching a target Web site, includes the steps of: a) providing an Internet portal site having a plurality of Web pages to a client computer in order to search the target Web site targeted by a user at the client computer, the Web pages including: “A” number of category chapters each containing “B” number of category icons where the “A” and the “B” are positive integers; and “C” number of Web-site link pages each containing “D” number of Web-site icons linked to one of the “B” number of category icons where the “C” and the “D” are the positive integers; b) providing at least one target Web page contained in the target Web site to the client computer; and c) displaying the target Web page contained in the target Web site. The Web-site icons and the category icons can be arranged according to the frequency number of use. Alternatively, the Web-site icons and the category icons can be arranged in alphabetic order.

### FIELD OF THE INVENTION

The present invention relates to a system and method for searching a World-Wide Web (hereinafter referred to as “Web”) site via an Internet network; and, more particularly, to a system and method for searching a target Web site by employing an Internet portal site having icons, which are arranged according to the frequency number of use.

### DESCRIPTION OF THE PRIOR ART

Generally, a user at a client computer employs an intermediate Web site contained in an intermediate server computer so as to search a target Web site contained in a target server computer. The client computer, the intermediate server computer and the target server computer are commonly coupled to an Internet network, respectively. The intermediate Web site and the target Web site are made up of a plurality of Web pages, respectively.

In order to search the target Web site, the user inputs a keyword, related to the target Web site, into the Web page of the intermediate Web site. Then, another Web page of the intermediate Web site displays a link of the target Web site. At this time, if the user at the client computer clicks the link of the target Web site, the target Web site is linked to the client computer, thereby providing the Web page, contained in the target Web site, to the client computer.

Otherwise, if the user inputs a domain name as a Web address corresponding to the target Web site into the Web page of the intermediate server computer, the intermediate server computer searches the target Web site having the domain name, thereby linking the client computer to the target Web site. Furthermore, the user needs an Internet portal site to more conveniently search the target Web site. Accordingly, there are strongly needed that an improved Internet portal site and an improved system for searching the target Web site through the improved Internet portal site.

### SUMMARY OF THE INVENTION

It is, therefore, an object of the present invention to provide a system and method for efficiently searching a target Web site and contents related to a keyword through an improved Internet portal site, which has category icons arranged according to the frequency number of category use and Web-site icons arranged according to the frequency number of Web-site use.

It is, therefore, another object of the present invention to provide a computer-readable medium storing program instructions, the program instructions disposed on a computer to perform a method for searching a target Web site through an improved Internet site, which has category icons arranged according to the frequency number of category use and Web-site icons arranged according to the frequency number of Web-site use.

In accordance with a first aspect of the present invention, there is provided a system for searching a target Web site, comprising: a server computer for providing an Internet portal site having a plurality of Web pages to a client computer in order to search the target Web site targeted by a user at said client computer, the Web pages including: “A” number of category chapters each containing “B” number of category icons where the “A” and the “B” are positive integers; and “C” number of Web-site link pages each containing “D” number of Web-site icons linked to one of the “B” number of category icons where the “C” and the “D” are the positive integers.

In accordance with a second aspect of the present invention, there is provided a system for searching a target Web site, comprising: an Internet network; a client computer, coupled to said Internet network, for displaying at least one target Web page contained in the target Web site, said client computer having a Web browser; an intermediate server computer, coupled to said Internet network, for providing an Internet portal site having a plurality of Web pages to said client computer in order to search the target Web site targeted by a user at the client computer, the Web pages including: “A” number of category chapters each containing “B” number of category icons where the “A” and the “B” are positive integers; and “C” number of Web-site link pages each containing “D” number of Web-site icons linked to one of the “B” number of category icons where the “C” and the “D” are the positive integers; and a target server computer, coupled to said Internet network, for providing the target Web page contained in the target Web site to said client computer.

In accordance with a third aspect of the present invention, there is provided a method for searching a target Web site, comprising the steps of: a) providing an Internet portal site having a plurality of Web pages to a client computer in order to search the target Web site targeted by a user at the client computer, the Web pages including: “A” number of category chapters each containing “B” number of category icons where the “A” and the “B” are positive integers; and “C” number of Web-site link pages each containing “D” number of Web-site icons linked to one of the “B” number of category icons where the “C” and the “D” are the positive integers; b) providing at least one target Web page contained in the target Web site to the client computer; and c) displaying the target Web page contained in the target Web site.

In accordance with a fourth aspect of the present invention, there is provided a computer-readable medium storing program instructions, the program instructions disposed on a computer to perform a method for searching a target Web site, the method comprising the steps of: a) providing an Internet portal site having a plurality of Web pages to a client computer in order to search the target Web site targeted by a user at the client computer, the Web pages including: “A” number of category chapters each containing “B” number of category icons where the “A” and the “B” are positive integers; and “C” number of Web-site link pages each containing “D” number of Web-site icons linked to one of the “B” number of category icons where the “C” and the “D” are the positive integers; b) providing at least one target Web page contained in the target Web site to the client computer; and c) displaying the target Web page contained in the target Web site.

### BRIEF DESCRIPTION OF THE DRAWINGS

The above and other objects and features of the instant invention will become apparent from the following description of preferred embodiments taken in conjunction with the accompanying drawings, in which:

FIG. 1 is an exemplary block diagram illustrating a system for searching a target Web site in accordance with the present invention;

FIG. 2 is an exemplary block diagram illustrating an intermediate server computer shown in FIG. 1;

FIG. 3 illustrates an exemplary initial display screen provided by an Internet portal site shown in FIG. 2;

FIG. 4 illustrates an exemplary array of category icons provided by an Internet portal site shown in FIG. 2;

FIG. 5 illustrates an exemplary array of Web-site icons provided by an Internet portal site shown in FIG. 2;

FIGS. 6A to 6D illustrate category chapters of Web pages provided by an Internet portal site shown in FIG. 2;

FIG. 6E illustrates a list of “80” category icons arranged in alphabetic order provided by an Internet portal site shown in FIG. 2;

FIGS. 7A to 7D illustrate Web-site link pages of Web pages provided by an Internet portal site shown in FIG. 2;

FIG. 7E illustrates a list of “80” Web-site icons arranged in alphabetic order provided by an Internet portal site shown in FIG. 2;

FIG. 8A illustrates a tree structure representing a relationship between category chapters and category icons shown in FIGS. 6A to 6D;

FIG. 8B illustrates a tree structure representing a relationship between a category icon representing “No. 1: HOME SHOPPING” shown in FIG. 4 and “80” Web-site icons shown in FIG. 5;

FIG. 9 illustrates a Web page including category icons and Web-site icons provided by an Internet portal site shown in FIG. 2;

FIG. 10 illustrates another Web page provided by an Internet portal site shown in FIG. 2;

FIG. 11 illustrates pop-up windows contained in another Web page shown in FIG. 10;

FIG. 12 illustrates a Web page containing a category chapter II linked to a category chapter I shown in FIG. 11;

FIG. 13 illustrates an exemplary flowchart of a method for searching a target Web site in accordance with the present invention;

FIG. 14 illustrates another exemplary flowchart of a method for searching a target Web site in accordance with the present invention;

FIG. 15 illustrates an exemplary flowchart of a method for searching contents related to a keyword in accordance with the present invention; and

FIG. 16 illustrates an exemplary flowchart of a method for searching a target Web site or contents in response to voice input data in accordance with the present invention.

### DETAILED DESCRIPTION OF THE INVENTION

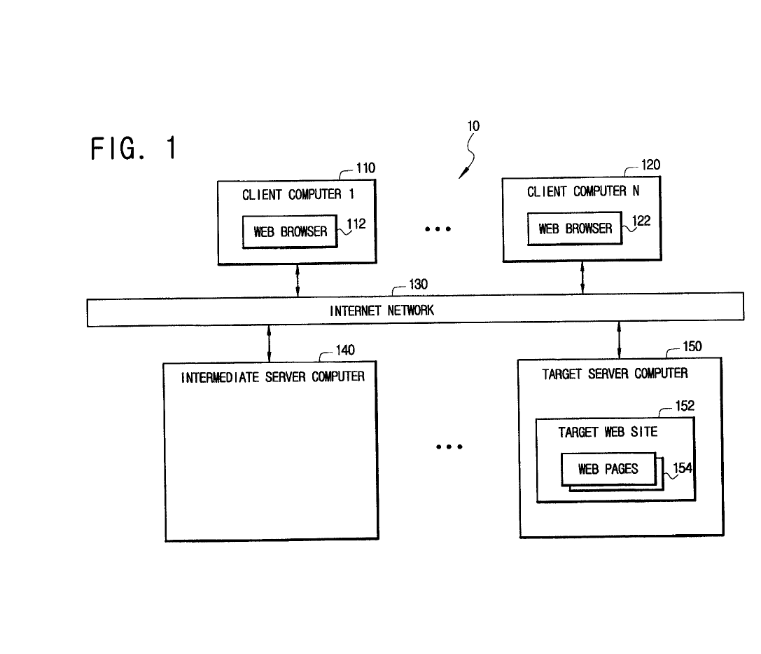

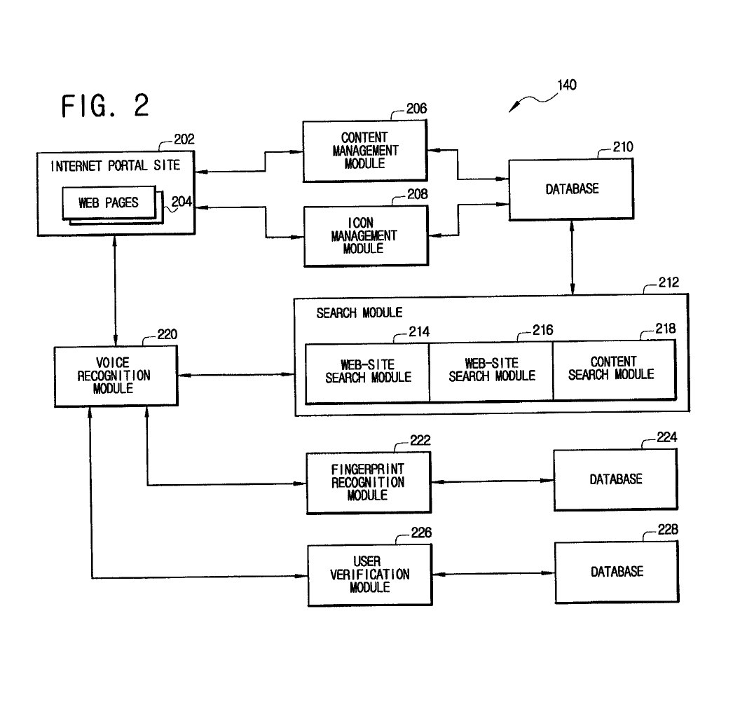

Referring to FIG. 1, there is shown an exemplary block diagram illustrating a system for searching a target Web site in accordance with the present invention. As shown, the system 10 includes client computers 110 and 120, an Internet network 130, an intermediate server computer 140 and a target server computer 150. The client computer 110 or 120, coupled to the Internet network 130, has a Web browser 112 or 122 as a software application. A user at the client computer 110 or 120 clicks a Web-browser icon to carry out the Web browser 112 or 122 corresponding to the intermediate server computer 140, wherein the Web-browser icon is displayed on a computer monitor (not shown) attached to the client computer 110 or 120. When the Web browser 112 or 122 is carried out by the user, the Web browser 112 or 122 connects the client computer 110 or 120 to the intermediate server computer 140 through the Internet network 130. The intermediate server computer 140 includes an Internet portal site 202 having a plurality of Web pages 204 as shown in FIG. 2. The intermediate server computer 140 provides the Web pages 204, contained in the Internet portal site 202, to the client computer 110 or 120. The client computer 110 or 120 inputs a domain name, corresponding to the target Web site 152, into one of the Web pages 204. Alternatively, the client computer 110 or 120 clicks a Web-site icon linked to the target Web site 152 in one of the Web pages 204. The target server computer 150 includes the target Web site 152, which is made up of a plurality of Web pages 154. After the Web-site icon is clicked or the domain name is inputted, the intermediate server computer 140 searches the target Web site 152 targeted by the user at the client computer 110 or 120.

Referring to FIG. 2, there is shown an exemplary block diagram illustrating an intermediate server computer shown in FIG. 1. As shown, the intermediate server computer 140 includes the Internet portal site 202, a content management module 206, an icon management module 208, databases 210, 224 and 228, a search module 212, a voice recognition module 220, a fingerprint recognition module 222 and a user verification module 226. The Internet portal site 202 includes the Web pages 204. The Web pages 204 includes “A” number of category chapters where the “A” is a positive integer. Each of the category chapters contains “B” number of category icons where the “B” is the positive integer. Further, The Web pages 204 include “C” number of Web-site link pages where the “C” is the positive integer. Each of the Web-site link pages contains “D” number of Web-site icons linked to one of the “B” number of category icons where the “D” is positive integers. The category icons are for categories of businesses and services. When it is assumed that the “A”, “B”, “C” and “D” are “4”, “20”, “4” and “20”, respectively, the Internet portal site 202 provides “6400” (=“4”×“20”×“4”×“20”) Web-site icons to the client computer 110 or 120 through the Web pages 204. The “B” and the “D” can be “80”, respectively. Alternatively, the “B” and the “D” can be in range between “20” and “80”, respectively. Further, the number of the Web-site icons can be over or below “6400”. The category icons can be arranged according to the frequency number of category use. The Web-site icons can be arranged according to the frequency number of Web-site use. Alternatively, the category icons and the Web-site icons can be arranged in alphabetic order. Colors of the category icons, which are contained in the category chapters, are variable according to the frequency number of category use. If the frequency number of category use with respect to a category icon is many, the color of the category icon becomes bright. Otherwise, if the frequency number of category use with respect to the category icon is less, the color of the category icon becomes dark. Similarly, colors of the Web-site icons, which are contained in the Web-site link pages, are variable according to the frequency number of Web-site use. If the frequency number of Web-site use with respect to a Web-site icon is many, the color of the Web-site icon becomes bright. Otherwise, if the frequency number of Web-site use with respect to the Web-site icon is less, the color of the Web-site icon becomes dark.

The search module 212, coupled to the database 210, searches the target Web site 152 targeted by the user at the client computer 110 or 120. The database 210 stores a mapping table including English-based domain names and Korean-based domain names. The Korean-based domain names are replaced with third language-based domain names. A third language contained in the term of “the third language-based domain names” includes a Japanese language, a Chinese language, a German language, a French language, an Italian language, a Latin language, a Russian language, a Spanish language, an Arab language, a Portuguese language, a Dutch language, a Hindustani language, etc. The database 210 further stores contents including words, images and links which the user at the client computer 110 or 120 can read and interact with. The database 210 further stores the category icons and the Web-site icons.

The search module 212, coupled to the database 210, is divided into Web-site search modules 214 and 216 and a content search module 218. The Web-site search module 214, coupled to the database 210, searches the target Web site 152 having an English-based domain name. Further, the Web-site search module 216, coupled to the database 210, identifies the target Web site 152 having the English-based domain name mapped to the Korean-based domain name. Hereinafter, the Web-site search module 216 searches the target Web site 152 having the English-based domain name mapped to the Korean-based domain name. Furthermore, the content search module 218 searches the contents related to a keyword, which is inputted by the user at the client computer 110 or 120.

The content management module 206 and the icon management module 208 are coupled between the Internet portal site 202 and the database 210, respectively. The content management module 206 manages the contents including the words, the images and the links which the user can read and interact with. The icon management module 208 manages the category icons contained in the category chapters and the Web-site icons contained in the Web-site link pages.

The voice recognition module 220, coupled to the search module 212, recognizes a voice input data inputted from a microphone (not shown), which is attached to the client computer 110 or 120. The Web-site search module 214 or 216 searches the target Web site 152 in response to the voice input data inputted from the voice recognition module 220. Similarly, the content search module 218 searches the contents related to the keyword, representing the voice input data, in response to the voice input data inputted from the voice recognition module 220.

The database 224 stores user information, e.g., user fingerprints. The fingerprint recognition module 222, coupled to the database 224, recognizes a user fingerprint outputted from the client computer 110 or 120, i.e., a mouse or a microphone, having a function of fingerprint recognition, attached to the client computer 110 or 120, by comparing the user fingerprint outputted from the client computer 110 or 120 to the user fingerprints stored in the database 224. At this time, the client computer 110 or 120 has a built-in program for recognizing the user fingerprint.

The database 228 includes the user information, e.g., user identities (IDs), passwords, etc. The user verification module 226, coupled to the database 228, verifies the user from a user input data inputted through a keyboard (not shown) by comparing the user input data to the user information stored in the database 228.

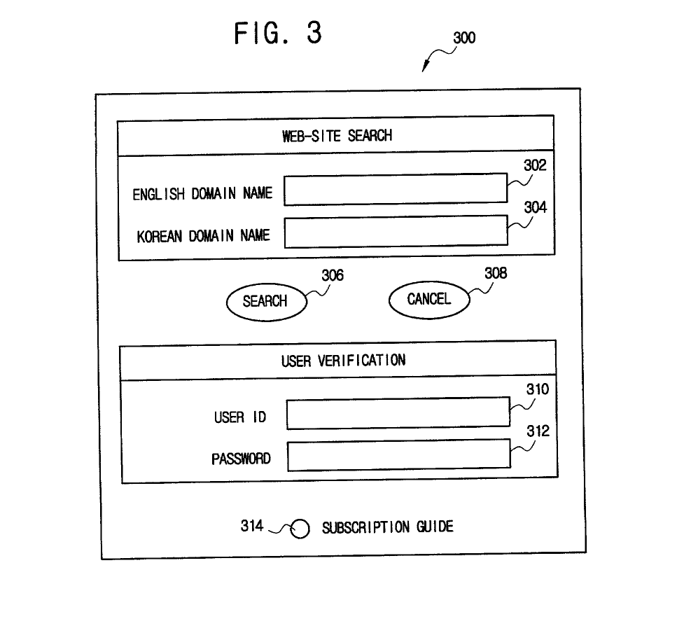

Referring to FIG. 3, there is shown an exemplary initial display screen provided by an Internet portal site shown in FIG. 2. As shown, an initial display screen 300 includes input boxes 302, 304, 310 and 312 and icons 306, 308 and 314. The user at the client computer 110 or 120 shown in FIG. 1 inputs the English-based domain name into the input box 302. Thereafter, if the user clicks the icon 306 necessary to search the Web site having the English-based domain name, the Web-site search module 214 shown in FIG. 2 searches the target Web site 152 shown in FIG. 1.

Similarly, the user inputs the Korean-based domain name into the input box 304. Thereafter, if the user clicks the icon 306 necessary to search the target Web site 152 having the English-based domain name mapped to the Korean-based domain name, the Web-site search module 216 identifies the English-based domain name mapped to the Korean-based domain name from the mapping table of the database 210 as shown in FIG. 2. The Web-site search module 216 searches the target Web site 152 having the English-based domain name mapped to the Korean-based domain name. Where the user inputs a user ID into the input box 310 and the user inputs a password into the input box 312, the user verification module 226 verifies the user by comparing the user ID and the password inputted with user IDs and passwords stored in the database 228 as shown in FIG. 2. At this time, if a plurality of users employ the same user ID as each other, the user verification module 226 disconnects a connection between the intermediate server computer 140 and the client computers related to the users.

Where the user clicks the icon 314, the Internet portal site 202 displays a display screen (not shown) related to a subscription guide. Where the user clicks the icon 308, the Web-site search module 214 or 216 cancels an on-going search in response to the icon 308 clicked by the user.

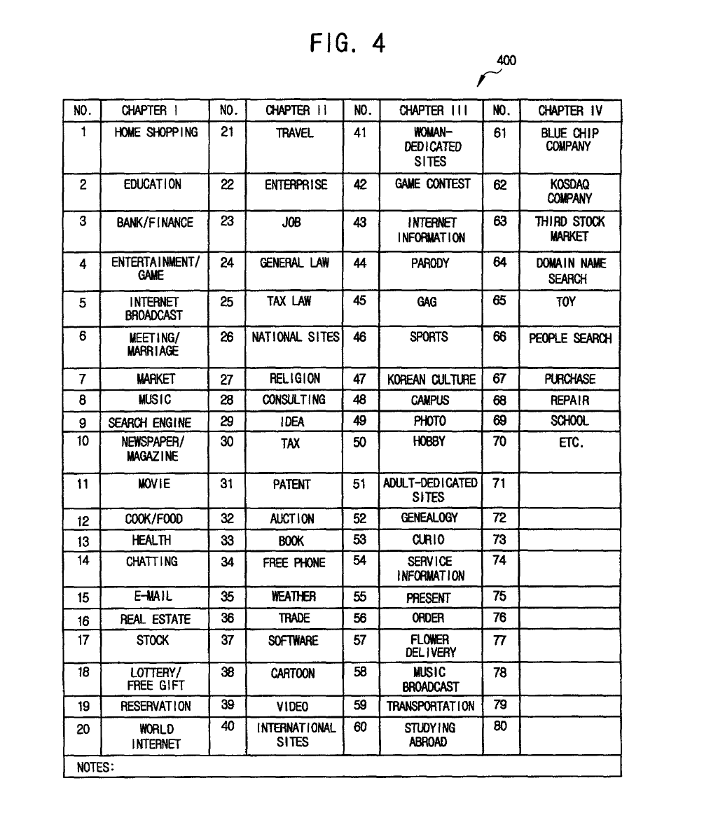

Referring to FIG. 4, there is shown an exemplary array of category icons provided by a Web page of an Internet portal site shown in FIG. 2. As shown, an array 400 is made up of four category chapters I, II, III and IV. The category chapter I includes category icons of Nos. 1 to 20. In order words, the category chapter I includes the category icons related to “No. 1: HOME SHOPPING”, “No. 2: EDUCATION”, “No. 3: BANK/FINANCE”, “No. 4: ENTERTAINMENT/GAME”, “No. 5: INTERNET BROADCAST”, “No. 6: MEETING/MARRIAGE”, “No. 7: MARKET”, “No. 8: MUSIC”, “No. 9: SEARCH ENGINE”, “No. 10: NEWSPAPER/MAGAZINE”, “No. 11: MOVIE”, “No. 12: COOK/FOOD”, “No. 13: HEALTH”, “No. 14: CHATTING”, “No. 15: E-MAIL”, “No. 16: REAL ESTATE”, “No. 17: STOCK”, “No. 18: LOTTERY/FREE GIFT”, “No. 19: RESERVATION” and “No. 20: WORLD INTERNET”.

The category chapter II includes category icons of Nos. 21 to 40. In order words, the category chapter II includes category icons related to “No. 21: TRAVEL”, “No. 22: ENTERPRISE”, “No. 23: JOB”, “No. 24: GENERAL LAW”, “No. 25: TAX LAW”, “No. 26: NATIONAL SITES”, “No. 27: RELIGION”, “No. 28: CONSULTING”, “No. 29: IDEA”, “No. 30: TAX”, “No. 31: PATENT”, “No. 32: AUCTION”, “No. 33: BOOK”, “No. 34: FREE PHONE”, “No. 35: WEATHER”, “No. 36: TRADE”, “No. 37: SOFTWARE”, “No. 38: CARTOON”, “No. 39: VIDEO” and “NO. 40: INTERNATIONAL SITES”.

The category chapter III includes the category icons of Nos. 41 to 60. In order words, the category chapter III includes category icons related to “No. 41: WOMAN-DEDICATED SITES”, “No. 42: GAME CONTEST”, “No. 43: INTERNET INFORMATION”, “No. 44: PARODY”, “No. 45: GAG”, “No. 46: SPORTS”, “No. 47: KOREAN CULTURE”, “No. 48: CAMPUS”, “No. 49: PHOTO”, “No. 50: HOBBY”, “No. 51: ADULT-DEDICATED SITES”, “No. 52: GENEALOGY”, “No. 53: CURIO”, “No. 54: SERVICE INFORMATION”, “No. 55: PRESENT”, “No. 56: ORDER”, “No. 57: FLOWER DELIVERY”, “No. 58: MUSIC BROADCAST”, “No. 59: TRANSPORTATION” and “No. 60: STUDYING ABROAD”.

The category chapter IV includes the category icons of Nos. 61 to 80. In order words, the category chapter IV includes category icons related to “No. 61: BLUE CHIP COMPANY”, “No. 62: KOSDAQ COMPANY”, “No. 63: THIRD STOCK MARKET”, “No. 64: DOMAIN NAME SEARCH”, “No. 65: TOY”, “No. 66: PEOPLE SEARCH”, “No. 67: PURCHASE”, “No. 68: REPAIR”, “No. 69: SCHOOL” and “No. 70: ETC.”. The category icons are for businesses and services. Each of the category icons is linked to four Web-site link pages (not shown). When the user at the client computer 110 or 120 clicks one of the category icons, the Internet portal site 202 displays the four Web-site link pages linked to the category icon clicked by the user. The four Web-site link pages can include Web-site icons or hypertext links for searching Web sites.

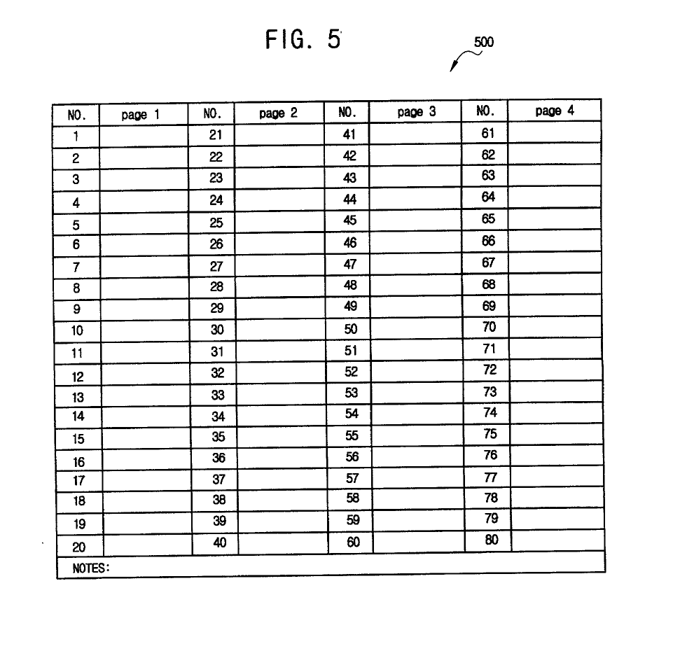

Referring to FIG. 5, there is shown an exemplary array of Web-site icons provided by a Web page of an Internet portal site shown in FIG. 2. As shown, an array 500 is made up of four Web-site link pages of Nos. 1, 2, 3 and 4. The Web-site link page of No. 1 includes Web-site icons of Nos. 1 to 20. The Web-site link page of No. 2 includes the Web-site icons of Nos. 21 to 40. The Web-site link page of No. 3 includes the Web-site icons of Nos. 41 to 60. The Web-site link page of No. 4 includes the Web-site icons of Nos. 61 to 80. Preferably, the Web-site icons are arranged according to the frequency number of Web-site use in the Web-site link pages of Nos. 1 to 4. When the user at the client computer 110 or 120 clicks one of the Web-site icons, the search module 212 searches the target Web site 152 corresponding to a Web-site icon clicked by the user. The search module 212 connects the client computer 110 or 120 to the target Web site 152 shown in FIG. 1.

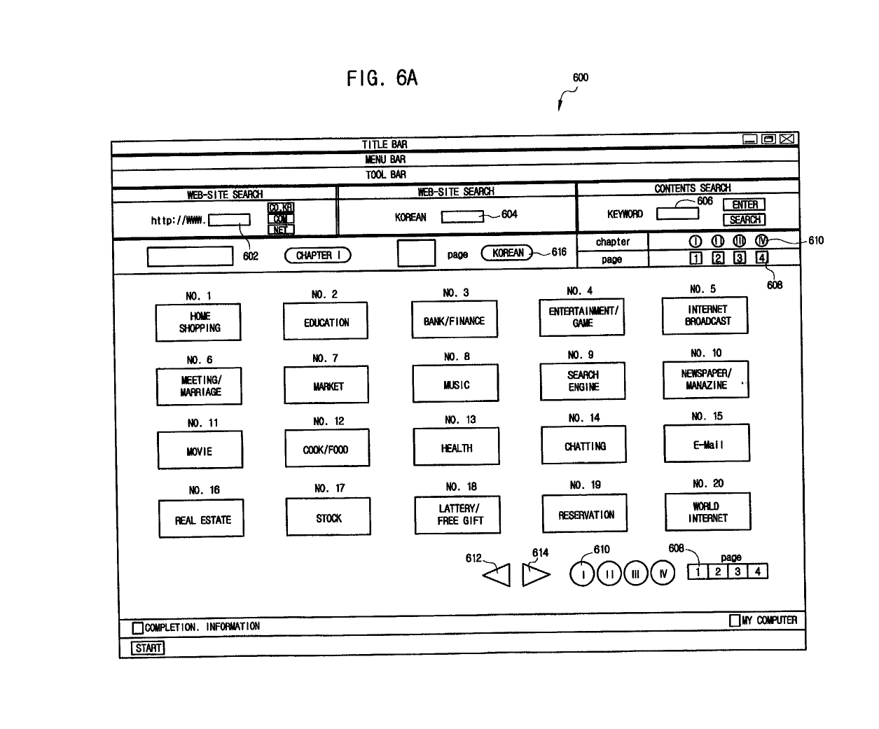

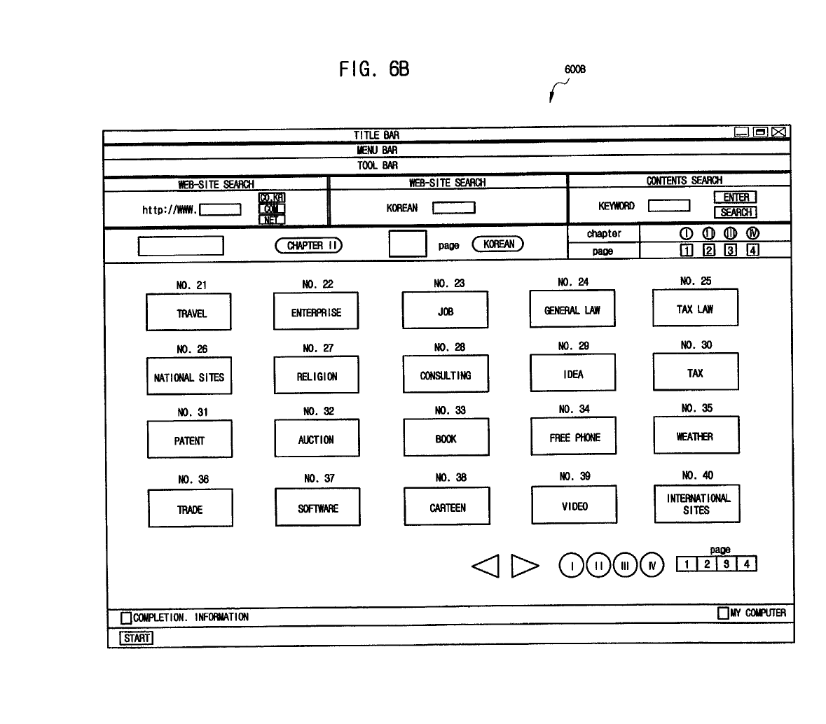

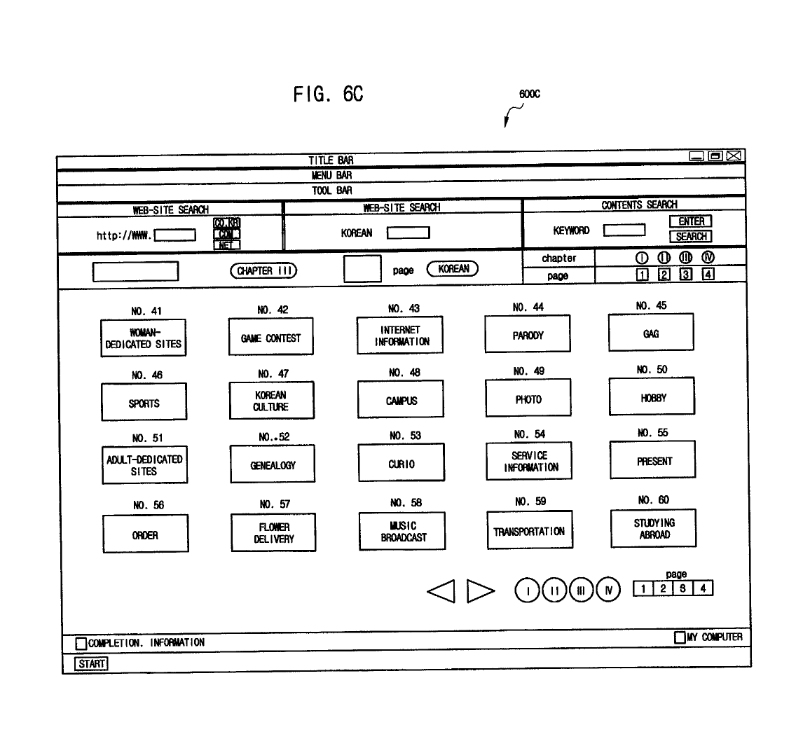

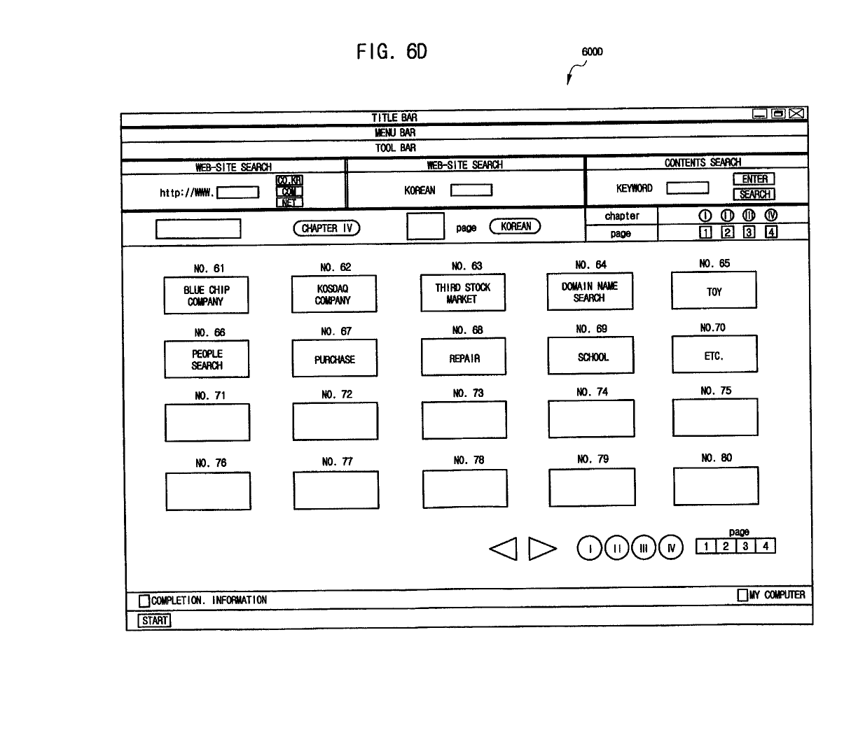

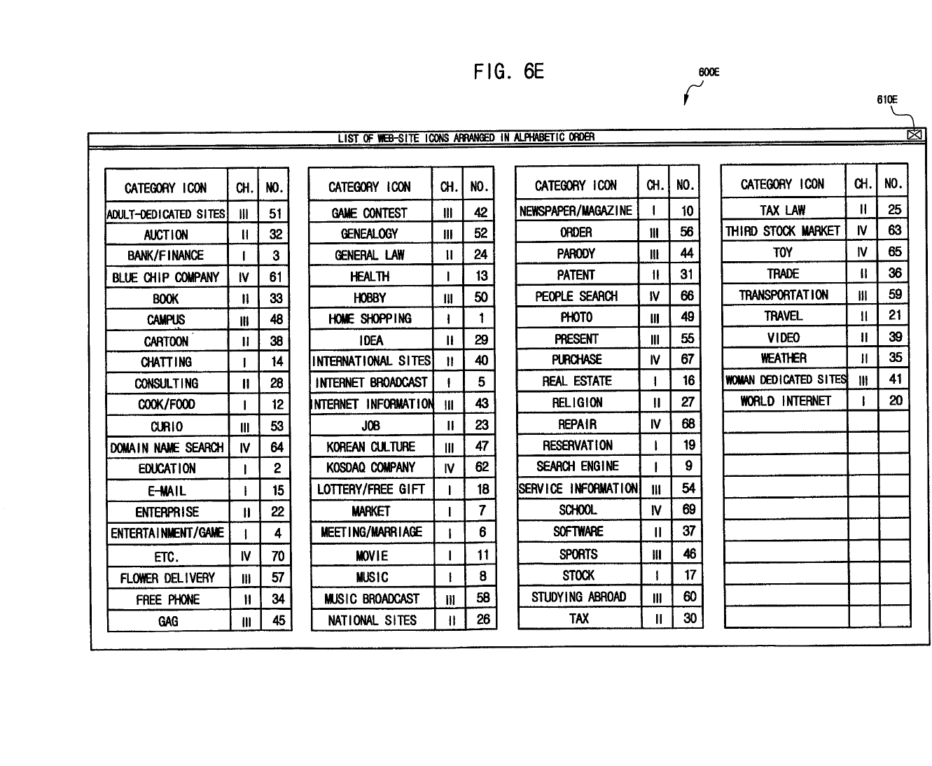

Referring to FIGS. 6A to 6D, there are shown category chapters of Web pages provided by an Internet portal site shown in FIG. 2. As shown in FIG. 6A, a Web page 600 includes input boxes 602, 604 and 606. Where the user inputs the English-based domain name into the input box 602, the Web-site search module 214 searches the target Web site 152 having the English-based domain name as shown in FIG. 2. Further, where the user inputs the Korean-based domain name into the input box 604, the Web-site search module 216 identifies the English-based domain name mapped to the Korean-based domain name from the mapping table stored in the database 210 as shown in FIG. 2. Hereinafter, the Web-site search module 216 searches the target Web site 152 having the English-based domain name identified from the database 210. Furthermore, where the user inputs the keyword into the input box 606, the content search module 218 searches the contents, related to the keyword, from the database 210 as shown in FIG. 2.

The Web page 600 includes an array of category icons. In other words, the Web page 600 displays the category icons of Nos. 1 to 20. Other Web page displays the category icons of Nos. 21 to 40, Nos. 41 to 60, or Nos. 61 to 80. The Web page 600 includes chapter icons 610 and Web-site link page icons 608. Where the user clicks a chapter icon 610, the Internet portal site 202 displays the chapter I, II, III or IV corresponding to the chapter icon 610 clicked by the user. Where the user clicks a Web-site link page icon 608, the Internet portal site 202 displays the Web-site link page of No. 1, 2, 3 or 4 corresponding to the Web-site link page icon 608 clicked by the user.

The Web page 600 includes a language conversion icon 616, a backward icon 612 and a forward icon 614. Where the user clicks the language conversion icon 616, the Web page 600 based on the English language is converted into that based on the Korean language. Where the user clicks the backward icon 612, a previous category chapter or Web-site link page is displayed. Where the user clicks the forward icon 614, a next category chapter or Web-site link page is displayed. Further, where the user clicks the language conversion icon 616 of “KOREAN”, the Internet portal site 202 displays a Web page based on the Korean language.

As shown in FIG. 6A, the Web page 600 includes a category chapter I, wherein the category chapter I has a plurality of category icons for businesses and services related to “No. 1: HOME SHOPPING”, “No. 2: EDUCATION”, “No. 3: BANK/FINANCE”, “No. 4: ENTERTAINMENT/GAME”, “No. 5: INTERNET BROADCAST”, “No. 6: MEETING/MARRIAGE”, “No. 7: MARKET”, “No. 8: MUSIC”, “No. 9: SEARCH ENGINE”, “No. 10: NEWSPAPER/MAGAZINE”, “No. 11: MOVIE”, “No. 12: COOK/FOOD”, “No. 13: HEALTH”, “No. 14: CHATTING”, “No. 15: E-MAIL”, “No. 16: REAL ESTATE”, “No. 17: STOCK”, “No. 18: LOTTERY/FREE GIFT”, “No. 19: RESERVATION” and “No. 20: WORLD INTERNET”. Where the user clicks a category icon related to “No. 5: INTERNET BROADCAST”, the Internet portal site 202 can display a web-site link page including Web-site icons related to a television (TV) broadcast, a cable television (CATV) broadcast, a satellite broadcast, an Internet broadcast, etc. Further, where the user clicks a category icon related to “No. 10: NEWSPAPER/MAGAZINE”, the Internet portal site 202 has domain names registered in the database 210 shown in FIG. 2 so that the user at the client computer 110 or 120 can display home pages provided by a daily newspaper company, a magazine company, a Webzine company, etc.

As shown in FIG. 6B, the Web page 600B includes a category chapter II, wherein the category chapter II has a plurality of category icons for businesses and services related to “No. 21: TRAVEL”, “No. 22: ENTERPRISE”, “No. 23: JOB”, “No. 24: GENERAL LAW”, “No. 25: TAX LAW”, “No. 26: NATIONAL SITES”, “No. 27: RELIGION”, “No. 28: CONSULTING”, “No. 29: IDEA”, “No. 30: TAX”, “No. 31: PATENT”, “No. 32: AUCTION”, “No. 33: BOOK”, “No. 34: FREE PHONE”, “No. 35: WEATHER”, “No. 36: TRADE”, “No. 37: SOFTWARE”, “No. 38: CARTOON”, “No. 39: VIDEO” and “NO. 40: INTERNATIONAL SITES”.

As shown in FIG. 6C, the Web page 600C includes a category chapter III, wherein the category chapter III has a plurality of category icons for businesses and services related to “No. 41: WOMAN-DEDICATED SITES”, “No. 42: GAME CONTEST”, “No. 43: INTERNET INFORMATION”, “No. 44: PARODY”, “No. 45: GAG”, “No. 46: SPORTS”, “No. 47: KOREAN CULTURE”, “No. 48: CAMPUS”, “No. 49: PHOTO”, “No. 50: HOBBY”, “No. 51: ADULT-DEDICATED SITES”, “No. 52: GENEALOGY”, “No. 53: CURIO”, “No. 54: SERVICE INFORMATION”, “No. 55: PRESENT”, “No. 56: ORDER”, “No. 57: FLOWER DELIVERY”, “No. 58: MUSIC BROADCAST”, “No. 59: TRANSPORTATION” and “No. 60: STUDYING ABROAD”.

As shown in FIG. 6D, the Web page 600D includes a category chapter IV, wherein the category chapter IV has a plurality of category icons for businesses and services related to “No. 61: BLUE CHIP COMPANY”, “No. 62: KOSDAQ COMPANY”, “No. 63: THIRD STOCK MARKET”, “No. 64: DOMAIN NAME SEARCH”, “No. 65: TOY”, “No. 66: PEOPLE SEARCH”, “No. 67: PURCHASE”, “No. 68: REPAIR”, “No. 69: SCHOOL” and “No. 70: ETC.”. Where the user clicks a category icon related to “No. 70: ETC.”, the Internet portal site 202 displays a Web page including other Web-site icons, which are not registered in the Internet portal site 202.

Referring to FIG. 6E, there is shown a list of “80” category icons arranged in alphabetic order provided by an Internet portal site shown in FIG. 2. As shown, a Web page 600E includes the list of “80” category icons arranged in alphabetic order. Alternatively, the Web page 600, 600B, 600C or 600D shown in FIG. 6A, 6B, 6C, or 6D can include an icon being clicked by the user so that the list of “80”category icons arranged in alphabetic order is displayed. Where the user clicks the icon contained in the Web page 600, 600B, 600C or 600D, the Internet portal site 202 displays the Web page 600E having the list of “80” category icons arranged in alphabetic order. Where a completion button 610E is pressed by the user, the Internet portal site 202 displays a previous Web page, e.g., the Web page 600, 600B, 600C or 600D. The list of “80” category icons cab be replaced with a list of “80” category hypertext links. Further, the Web page 600E is replaced with a pop-up window having the list of “80” category icons or the list of “80” category hypertext links.

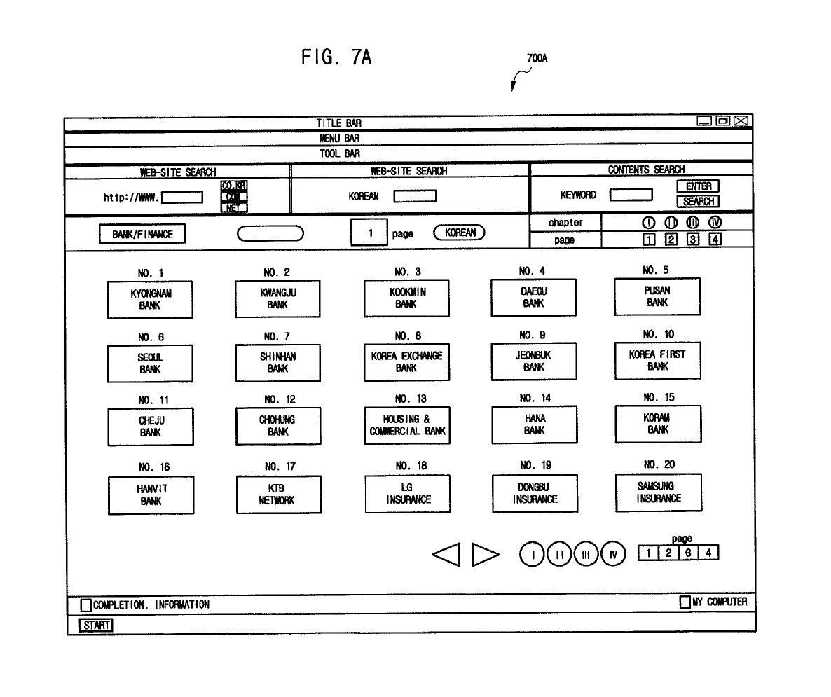

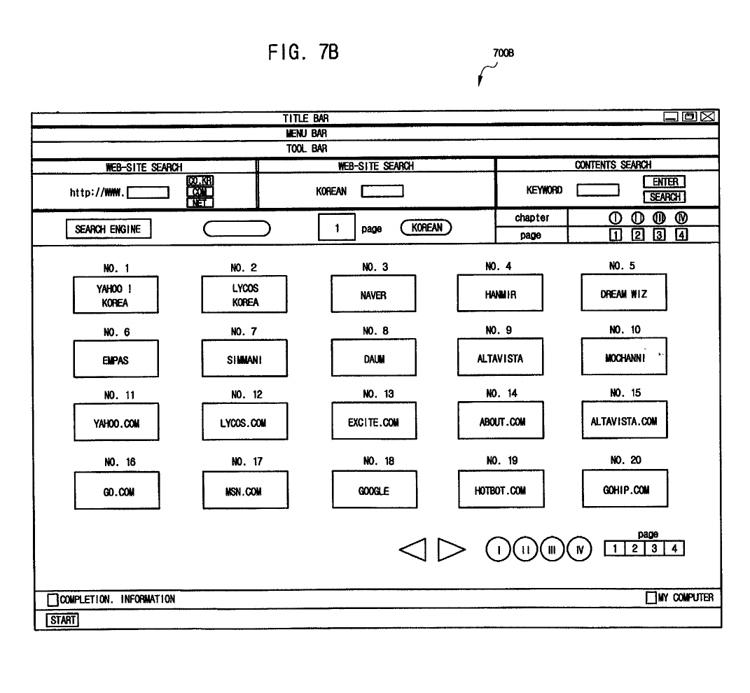

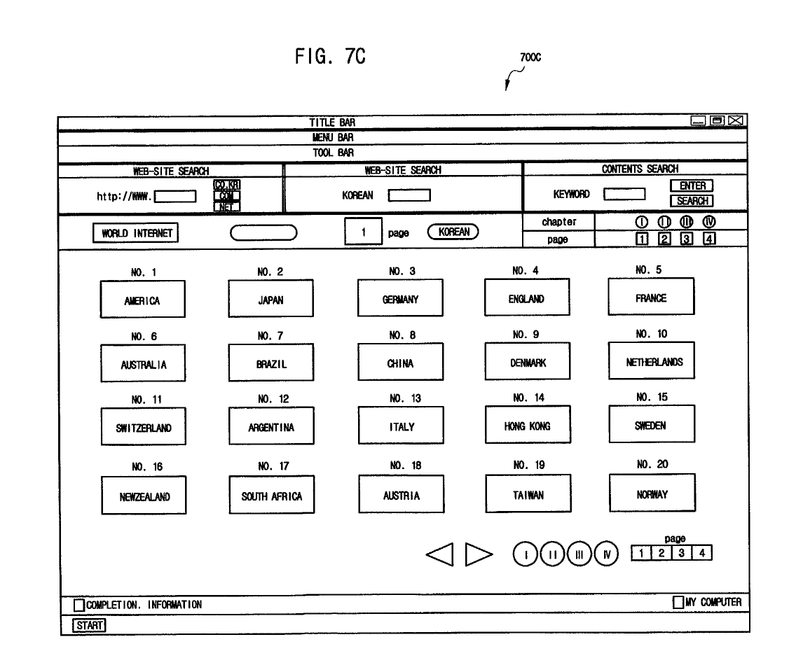

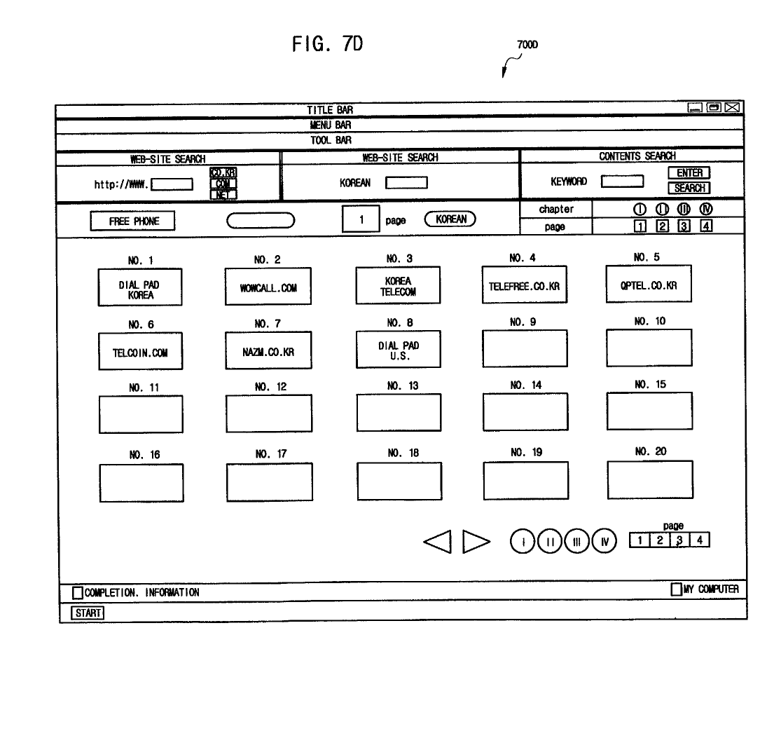

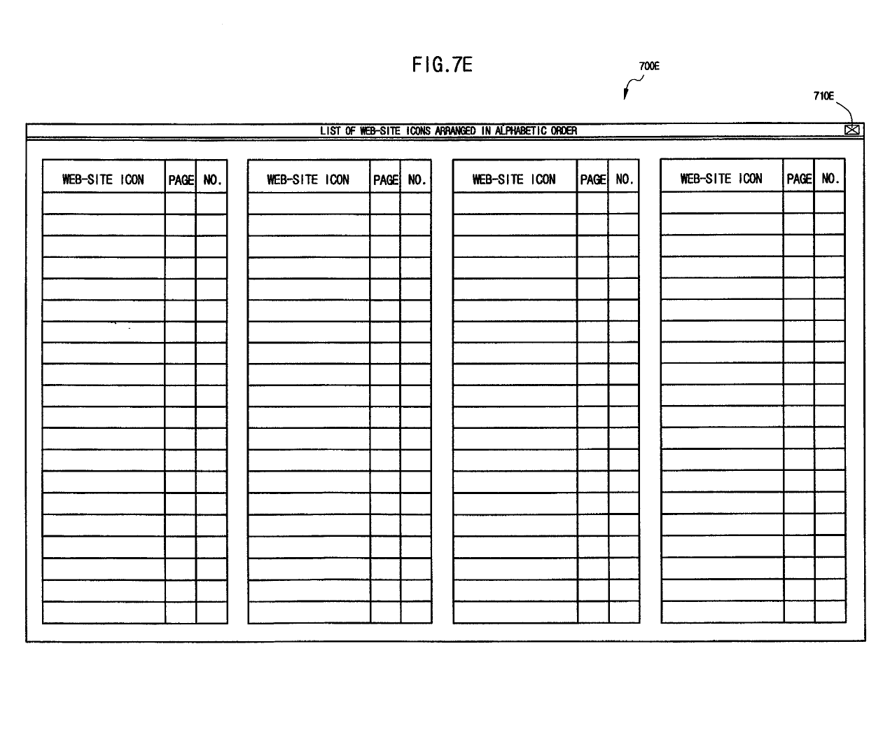

Referring to FIGS. 7A to 7D, there are shown Web-site link pages of Web pages provided by an Internet portal site shown in FIG. 2. Where the user clicks the category icon related to “No. 3: bank/finance” shown in FIG. 6A, the Internet portal site 202 provides a Web-site link page of No. 1, corresponding to the clicked category icon, contained in a Web page 700A to the computer monitor of the client computer 110 or 120 as shown in FIG. 7A. The Web-site link page of No. 1, which corresponds to the clicked category icon related to “No. 3: BNAK/FINANCE”, has Web-site icons for businesses and services related to “No. 1: KYONGNAM BANK”, “No. 2: KWANGJU BANK”, “No. 3: KOOKMIN BANK”, “No. 4: DAEGU BANK”, “No. 5: PUSAN BANK”, “No. 6: SEOUL BANK”, “No. 7: SHINHAN BANK”, “No. 8: KOREA EXCHANGE BANK”, “No. 9: JEONBUK BANK”, “No. 10: KOREA FIRST BANK”, “No. 11: CHEJU BANK”, “No. 12: CHOHUNG BANK”, “No. 13: HOUSING & COMMERCIAL BANK”, “No. 14: HANA BANK”, “No. 15: KORAM BANK”, “No. 16: HANVIT BANK”, “No. 17: KTB NETWORK”, “No. 18: LG INSURANCE”, “No. 19: DONGBU INSURANCE” and “No. 20: SAMSUNG INSURANCE”.

Further, where the user clicks the category icon related to “No. 9: SEARCH ENGINE” shown in FIG. 6A, the Internet portal site 202 provides a Web-site link page of No. 1, corresponding to the clicked category icon, contained in a Web page 700B to the computer monitor of the client computer 110 or 120 as shown in FIG. 7B. The Web-site link page of No. 1, which corresponds to the clicked category icon related to “No. 9: SEARCH ENGINE”, has Web-site icons for businesses and services related to “No. 1: YAHOO! KOREA”, “No. 2: LYCOS KOREA”, “No. 3: NAVER”, “No. 4: HANMIR”, “No. 5: DREAMWIZ”, “No. 6: EMPAS”, “No. 7: SIMMANI”, “No. 8: DAUM”, “No. 9: ALTAVISTA”, “No. 10: MOCHANNI”, “No. 11: YAHOO.COM”, “No. 12: LYCOS.COM”, “No. 13: EXCITE.COM”, “No. 14: ABOUT.COM”, “No. 15: ALTAVISTA.COM”, “No. 16: GO.COM”, “No. 17: MSN.COM”, “No. 18: GOOGLE”, “No. 19: HOTBOT.COM” and “No. 20: GOHIP.COM”.

Furthermore, where the user clicks the category icon related to “No. 20: WORLD INTERNET” shown in FIG. 6A, the Internet portal site 202 provides a Web-site link page of No. 1, corresponding to the clicked category icon, contained in a Web page 700C to the computer monitor of the client computer 110 or 120 as shown in FIG. 7C. The Web-site link page of No. 1, which corresponds to the clicked category icon related to “No. 20: WORLD INTERNET”, has Web-site icons for businesses and services related to “No. 1: AMERICA”, “No. 2: JAPAN”, “No. 3: GERMANY”, “No. 4: ENGLAND”, “No. 5: FRANCE”, “No. 6: AUSTRALIA”, “No. 7: BRAZIL”, “No. 8: CHINA”, “No. 9: DENMARK”, “No. 10: NETHERLANDS”, “No. 11: SWITZERLAND”, “No. 12: ARGENTINA”, “No. 13: ITALY”, “No. 14: HONG KONG”, “No. 15: SWEDEN”, “No. 16: NEW ZEALAND”, “No. 17: SOUTH AFRICA”, “No. 18: AUSTRIA”, “No. 19: TAIWAN” and “No. 20: NORWAY”. Where the user clicks a Web-site icon, the Internet portal site 202 can connect the client computer 110 or 120 to a contents provider (CP) corresponding to the clicked Web-site icon by employing an Internet protocol (IP) address corresponding to the clicked Web-site icon.

Still furthermore, where the user clicks the category icon related to “No. 34: FREE PHONE” shown in FIG. 6B, the Internet portal site 202 provides a Web-site link page of No. 1, corresponding to the clicked category icon, contained in a Web page 700D to the computer monitor of the client computer 110 or 120 as shown in FIG. 7D. The Web-site link page of No. 1, which corresponds to the clicked category icon related to “NO. 34: FREE PHONE”, has web-site icons for businesses and services related to “No. 1: DIAL PAD KOREA”, “No. 2: WOWCALL.COM”, “No. 3: KOREA TELECOM”, “No. 4: TELEFREE.CO.KR”, “NO. 5: QPTEL.CO.KR”, “No. 6: TELCOIN.COM”, “No. 7: NAZM” and “No. 8: DIAL PAD U.S.”.

Referring to FIG. 7E, there is shown a list of “80” web-site icons arranged in alphabetic order provided by an Internet portal site shown in FIG. 2. As shown, a Web page 700E includes the list of “80” Web-site icons arranged in alphabetic order. Alternatively, the Web page 700A, 700B, 700C or 700D shown in FIG. 7A, 7B, 7C or 7D can include an icon being clicked by the user so that the list of “80” Web-site icons arranged in alphabetic order is displayed. Where the user clicks the icon contained in the Web page 700A, 700B, 700C or 700D, the Internet portal site 202 displays the Web page 700E having the list of “80” Web-site icons arranged in alphabetic order. Where a completion button 710E is pressed by the user, the Internet portal site 202 displays a previous Web page, e.g., the Web page 700A, 700B, 700C or 700D. The list of “80” Web-site icons cab be replaced with a list of “80” Web-site hypertext links. Further, the Web page 700E is replaced with a pop-up window having the list of “80” Web-site icons or the list of “80” Web-site hypertext links.

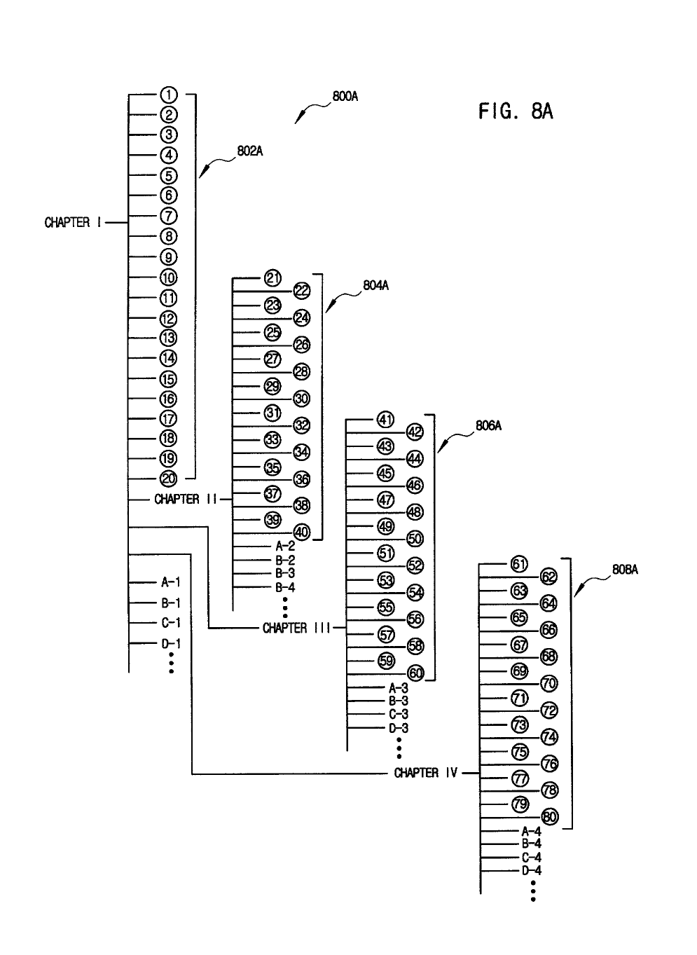

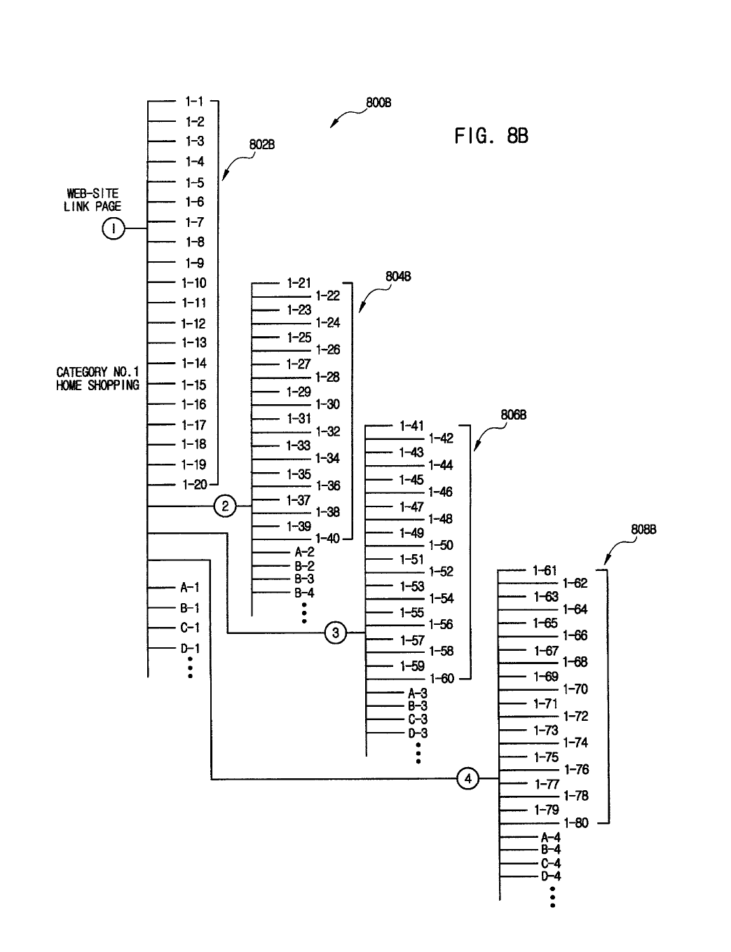

Referring to FIG. 8A, there is shown a tree structure representing a relationship between category chapters and category icons shown in FIGS. 6A to 6D. As shown in a tree structure 800A, a reference numeral “802A” denotes the category icons of Nos. 1 to 20 contained in the category chapter I. A reference numeral “804A” denotes the category icons of Nos. 21 to 40 contained in the category chapter II. A reference numeral “806A” denotes the category icons of Nos. 41 to 60 contained in the category chapter III. A reference numeral “808A” denotes the category icons of Nos. 61 to 80 contained in the chapter IV. As a result, the category chapters I, II, III and IV are linked to the category icons of Nos. 1 to 20, Nos. 21 to 40, Nos. 41 to 60 and Nos. 61 to 80, respectively.

Referring to FIG. 8B, there is shown a tree structure representing a relationship between a category icon representing “No. 1: HOME SHOPPING” shown in FIG. 4 and “80” Web-site icons shown in FIG. 5. As shown in a tree structure 800B, a reference numeral “802B” denotes the Web-site icons of Nos. 1 to 20 contained in the Web-site link page of No. 1. A reference numeral “804B” denotes the Web-site icons of Nos. 21 to 40 contained in the Web-site link page of No. 2. A reference numeral “806B” denotes the Web-site icons of Nos. 41 to 60 contained in the Web-site linkpage of No. 3. A reference numeral “808B” denotes the Web-site icons of Nos. 61 to 80 contained in the Web-site link page of No. 4. As a result, the Web-site link pages of Nos. 1, 2, 3 and 4 are linked to the Web-site icons of Nos. 1 to 20, Nos. 21 to 40, Nos. 41 to 60 and Nos. 61 to 80, respectively. Those skilled in the art can readily understand that a tree structure representing a relationship between remaining category icons shown in FIG. 4 and “80” Web site icons shown in FIG. 5 is omitted.

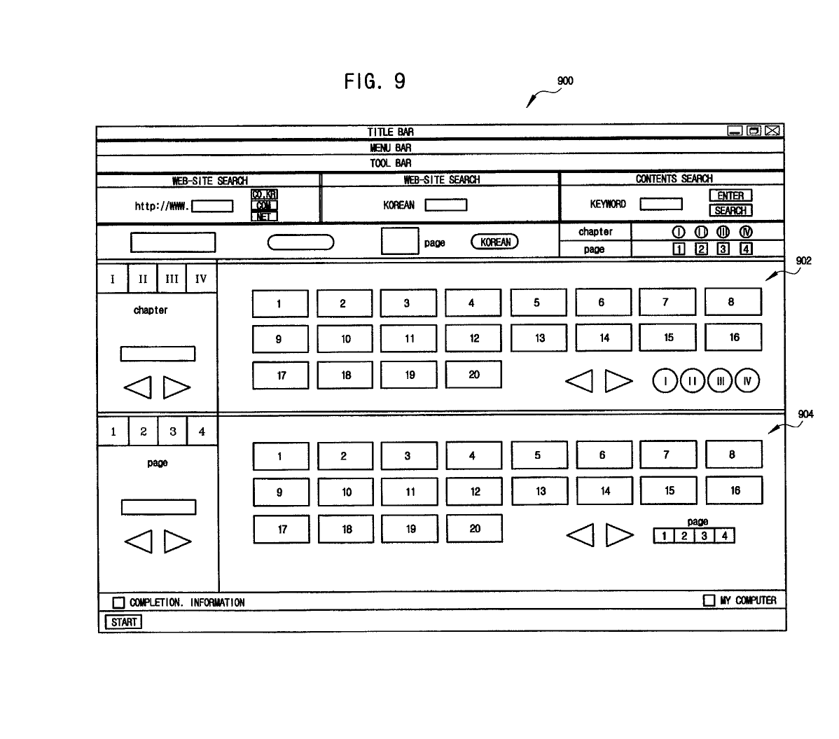

Referring to FIG. 9, there is shown a Web page including category icons and Web-site icons provided by an Internet portal site shown in FIG. 2. As shown, a Web page 900 includes icon-display spaces 902 and 904. The icon-display space 902 displays an array of category icons contained in one of category chapters I, II, III and IV. The array of the category icons has “20” category icons contained in the icon-display space 902. Further, the icon-display space 904 displays an array of Web-site icons contained in one of the Web-site link pages of Nos. 1, 2, 3 and 4. The array of Web-site icons has “20” category icons contained in the icon-display space 904.

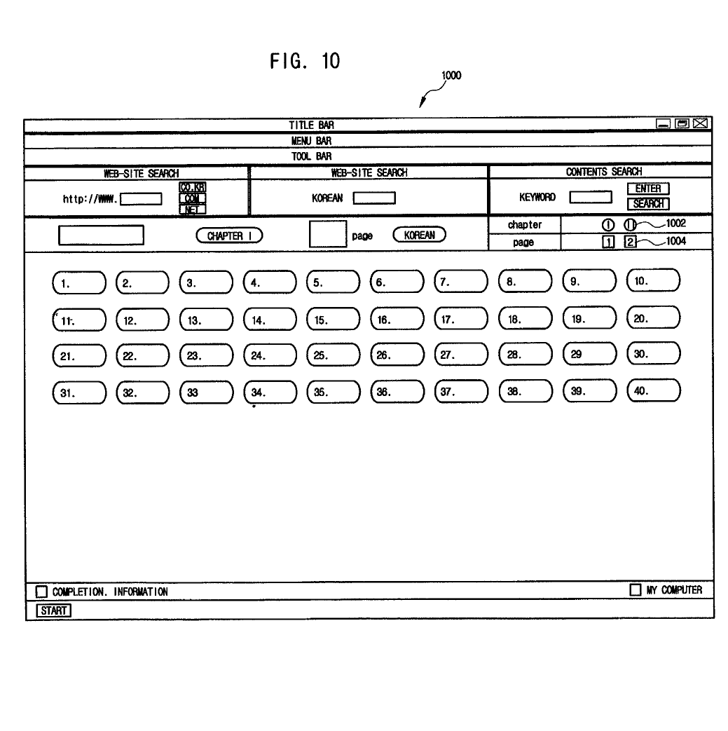

Referring to FIG. 10, there is shown another Web page provided by an Internet portal site shown in FIG. 2. As shown, a Web page 1000 includes “40” category icons contained in a category chapter I. A category chapter II contains other “40” category icons. The Web page 1000 includes chapter icons 1002 and Web-site link page icons 1004. Where the user clicks a chapter icon 1002, the Internet portal site 202 displays the category chapter I or II corresponding to the chapter icon 1002 clicked by the user. Where the user clicks a Web-site link page icon 1004, the Internet portal site displays the Web-site link page of No. 1 or 2 corresponding to the Web-site link page icon 1004 clicked by the user.

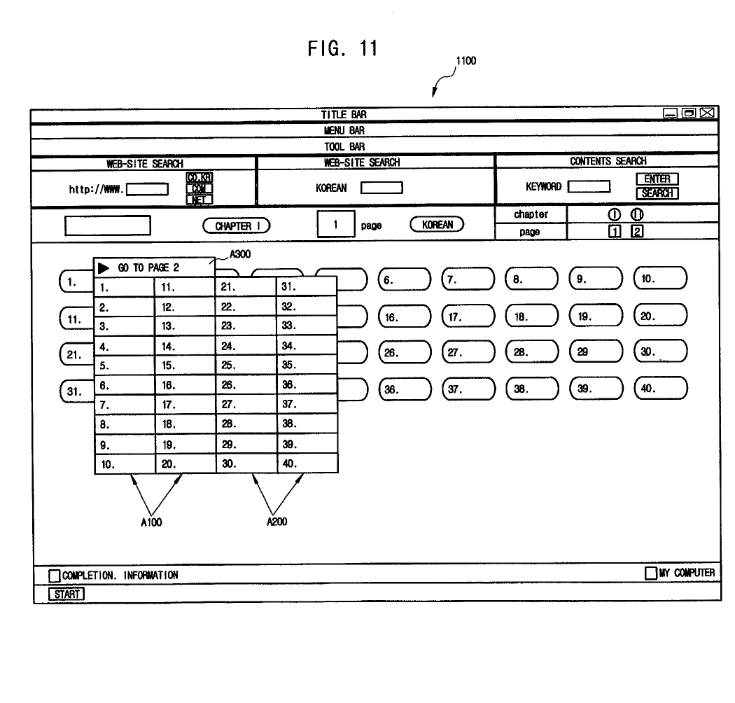

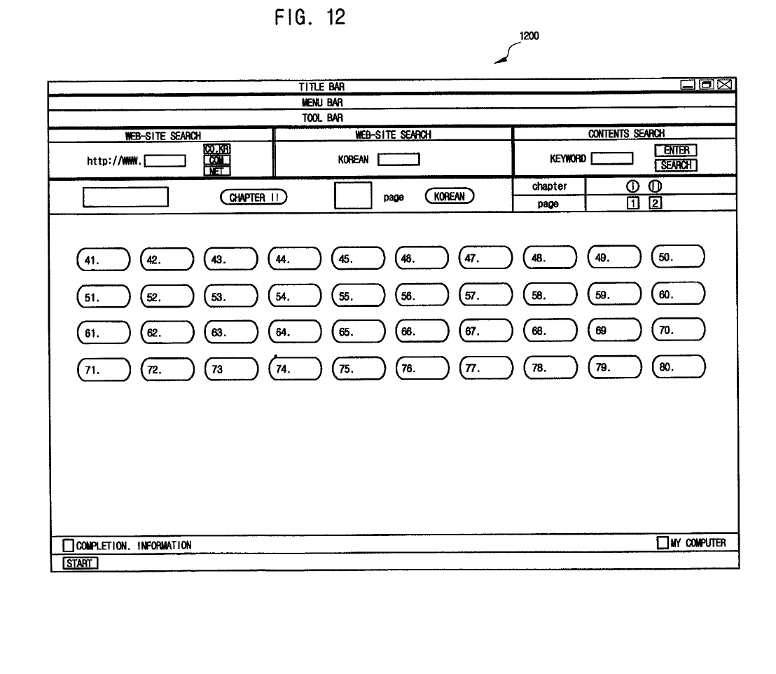

Referring to FIG. 11, there is shown pop-up windows contained in another Web page shown in FIG. 10. As shown, the Web page 1100 includes pop-up windows A100 and A200. Where a pointer is put on a category icon for a predetermined time period, the pop-up windows A100 and A200 related to the category icon are displayed. The pop-up windows A100 and A200 include Web-site icons. Further, where the user at the client computer 110 or 120 clicks an icon A300 of “GO TO PAGE 2”, the Web-site link page of No. 2 is displayed. The pop-up window A100 includes the Web-site icons of Nos. 1 to 20, which are arranged according to the frequency number of web-site use. Further, the pop-up window A200 includes the Web-site icons of Nos. 21 to 40, which are arranged in alphabetic order. The Web-site icons can be updated at predetermined time periods, e.g., years and months. Referring to FIG. 12, there is shown a Web page containing a category chapter II linked to a category chapter I shown in FIG. 11. As shown, a Web page 1200 includes a category chapter II not shown in FIG. 11, wherein the category chapter II includes “40” category icons of Nos. 41 to 80.

Alternatively, a Web page, which displays a category chapter I, II, III or IV, can include a pop-up window icon. Where the user clicks the pop-up window icon, the Web page displays a pop-up window containing category icons, wherein the category icons are arranged from bottom to top in the pop-up window according to the frequency number of category use. Further, a Web page, which displays a Web-site link page of No. 1, 2, 3 or 4, can include the pop-up window icon. Where the user clicks the pop-up window icon, the Web page displays a pop-up window containing Web-site icons, wherein the Web-site icons are arranged from bottom to top in the pop-up window according to the frequency number of Web-site use. In order to display the pop-up window, the client computer 110 or 120, or the intermediate server computer 140 has a built-in program capable of checking the frequency number of category use or the frequency number of Web-site use.

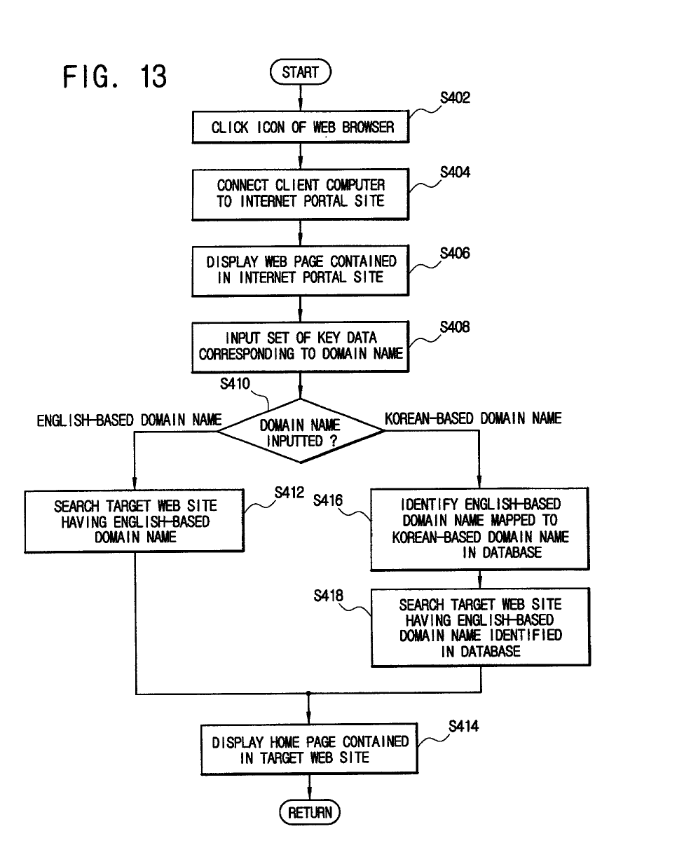

Referring to FIG. 13, there is shown a flowchart of a method for searching a target Web site in accordance with the present invention. As shown, the user at the client computer 110 or 120 clicks, at step S402, an icon of the Web browser 112 or 122 displayed on a computer monitor of the client computer 110 or 120 as shown in FIG. 1. Then, the Web browser 112 or 122 connects, at step S404, the client computer 110 or 120 to the Internet portal site 202, contained in the intermediate server computer 140, over the Internet network 130. Then, the computer monitor of the client computer 110 or 120 displays, at step S406, a Web page 600 contained in the Internet portal site 202 as shown in FIG. 6A.

Thereafter, the user inputs, at step S408, a set of key data corresponding to the domain name. The set of key data is inputted through a keyboard attached to the client computer 110 or 120. If the user inputs the English-based domain name into the input box 602 as shown in FIG. 6A, the Web-site search module 214 searches a target Web site 152 having the English-based domain name as shown in FIG. 2. Otherwise, if the user inputs the Korean-based domain name into an input box 604 as shown in FIG. 6A, the Web-site search module 216 searches the target Web site 152 having the English-based domain name mapped to the Korean-based domain name as a native-based domain name as shown in FIG. 2.

Thereafter, at step S410, it is determined whether the domain name inputted is the English-based domain name or the Korean-based domain name. Then, if the domain name inputted is the English-based domain name, the Web-site search module 214 searches, at step S412, the target Web site 152 having the English-based domain name. The computer monitor of the client computer 110 or 120 displays, at step S414, the Web page 154 contained in the target Web site 152 as shown in FIG. 1.

Otherwise, if the domain name inputted is the Korean-based domain name, the Web-site search module 216 identifies, at step S416, the English-based domain name mapped to the Korean-based domain name in the database 210, which stores a mapping table made up of English-based domain names and Korean-based domain names as shown in FIG. 2. Then, the Web-site search module 216 searches, at step S418, the target Web site 152 having the English-based domain name identified in the database 210. Then, the computer monitor of the client computer 110 or 120 displays, at step S414, the Web page 154 contained in the target Web site 152.

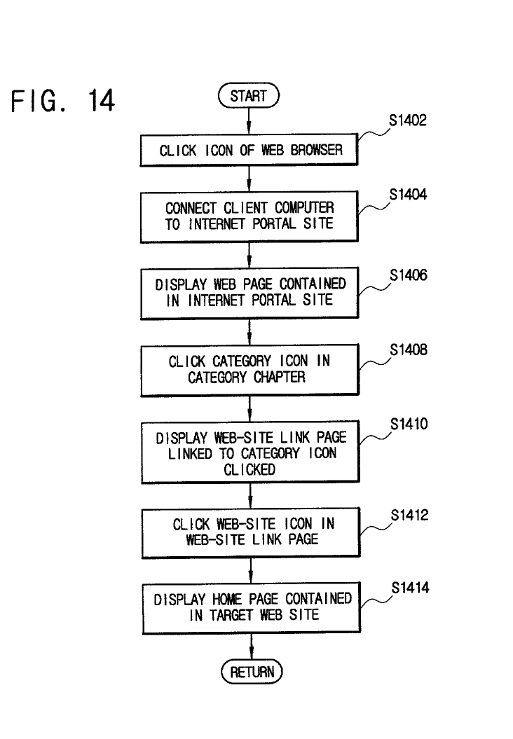

Referring to FIG. 14, there is shown another exemplary flowchart of a method for searching a target Web site in accordance with the present invention. As shown, the user at the client computer 110 or 120 clicks, at step S1402, an icon of the Web browser 112 or 122 displayed on a computer monitor of the client computer 110 or 120 as shown in FIG. 1. Then, the Web browser 112 or 122 connects, at step S1404, the client computer 110 or 120 to the Internet portal site 202, contained in the intermediate server computer 140, over the Internet network 130. Then, the computer monitor of the client computer 110 or 120 displays, at step S1406, the Web page 600 contained in the Internet portal site 202 as shown in FIG. 6A.

Thereafter, the user clicks, at step S1408, a category icon contained in a category chapter as shown in FIG. 6A. Then, the Internet portal site 202 displays, at step S1410, at least one Web-site link page linked to the category icon clicked by the user. Then, the user clicks, at step S1412, a Web-site icon contained in the Web-site link page. Then, the computer monitor of the client computer 110 or 120 displays, at step S1414, the Web page 154 contained in the target Web site 152.

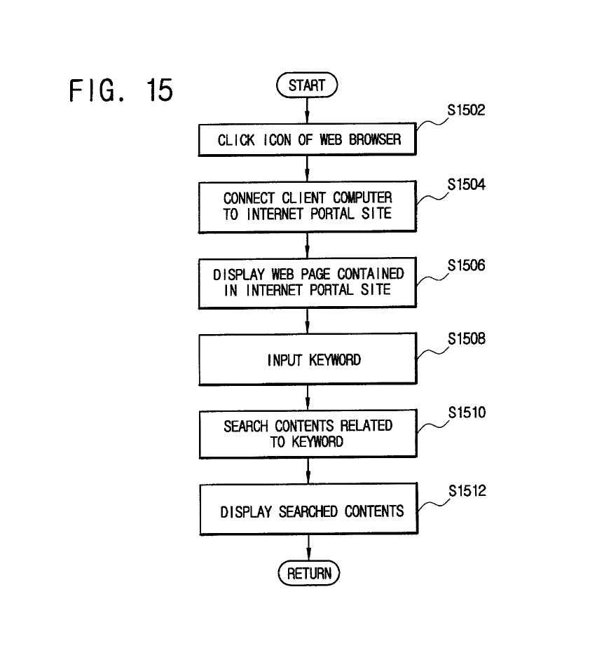

Referring to FIG. 15, there is shown an exemplary flowchart of a method for searching contents related to a keyword in accordance with the present invention. As shown, the user at the client computer 110 or 120 clicks, at step S1502, an icon of the Web browser 112 or 122 displayed on a computer monitor of the client computer 110 or 120 as shown in FIG. 1. Then, the Web browser 112 or 122 connects, at step S1504, the client computer 110 or 120 to the Internet portal site 202, contained in the intermediate server computer 140, over the Internet network 130. Then, the computer monitor of the client computer 110 or 120 displays, at step S1506, the Web page 600 contained in the Internet portal site 202 as shown in FIG. 6A.

Thereafter, the user inputs, at step S1508, the keyword into the input box 606 contained in the Web page 600 as shown in FIG. 6A. Then, the content search module 218 searches, at step S1510, the contents related to the keyword from the database 210 as shown in FIG. 2, wherein the contents include words, images and links which the user can read and interact with. Then, the Internet portal site 202 displays, at step S1512, the searched contents.

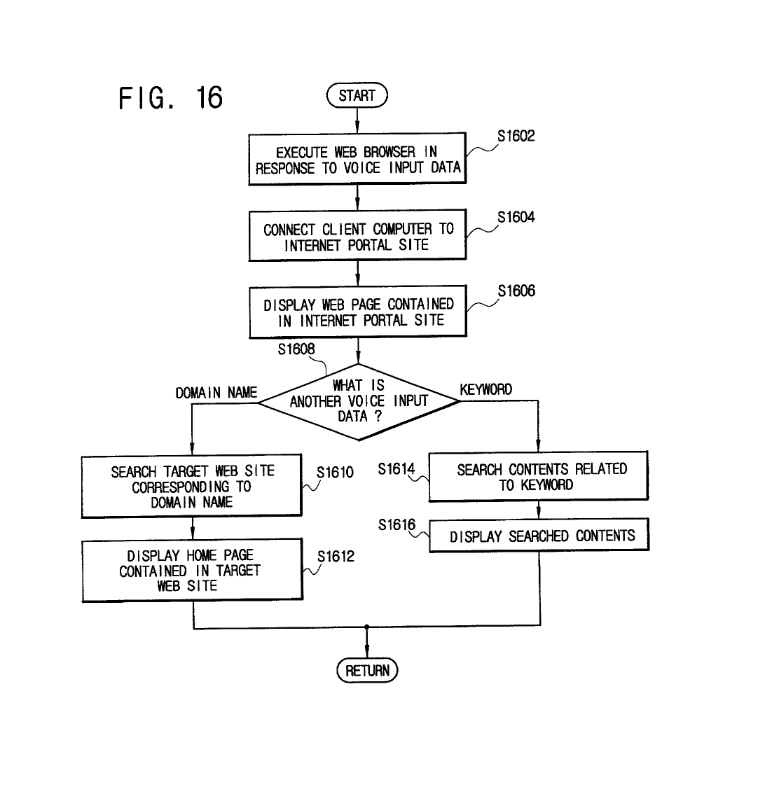

Referring to FIG. 16, there is shown an exemplary flowchart of a method for searching a target Web site or contents in response to voice input data in accordance with the present invention. As shown, the client computer 110 or 120 shown in FIG. 1 executes, at step S1602, the web browser 112 or 122 in response to a voice input data. Then, the Web browser 112 or 122 connects, at step S1604, the client computer 110 or 120 to the Internet portal site 202, contained in the intermediate server computer 140, over the Internet network 130. Then, a computer monitor of the client computer 110 or 120 displays, at step S1606, the Web page 600 contained in the Internet portal site 202 as shown in FIG. 6A.

Thereafter, at step S1608, it is determined whether another voice data is a domain name or a keyword. If another voice input data is the domain name, the Web-site search module 214 or 216 searches, at step S1610, the target Web site 152 corresponding to the domain name representing another voice input data as shown in FIG. 2. Then, the computer monitor of the client computer 110 or 120 displays, at step S1612, the Web page 154 contained in the target Web site 152.

Otherwise, if another voice input data is the keyword, the content search module 218, responsive to another voice input data, searches, at step S1614, the contents related to the keyword from the database 210 as shown in FIG. 2, wherein the contents include words, images and links which the user can read and interact with. Then, the Internet portal site 202 shown in FIG. 2 displays, at step S1616, the searched contents.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A system for searching a target Web site, comprising:
a server computer for providing an Internet portal site having a plurality of Web pages to a client computer in order to search the target Web site targeted by a user at said client computer, the Web pages including:
“A” number of category chapters each containing “B” number of category icons where the “A” and the “B” are positive integers; and
“C” number of Web-site link pages each containing “D” number of Web-site icons linked to one of the “B” number of category icons where the “C” and the “D” are the positive integers.

2. The system as recited in claim 1, wherein the Web-site icons are arranged according to the frequency number of Web-site use and the category icons are arranged according to the frequency number of category use.

3. The system as recited in claim 1, wherein the Web-site icons are arranged in alphabetic order and the category icons are arranged in alphabetic order.

4. The system as recited in claim 1, wherein said server computer includes:
a search means for searching the target Web site targeted by the user at said client computer.

5. The system as recited in claim 4, wherein said search means includes:
a first search means for searching the target Web site having a first language-based domain name; and
a second search means for searching the target Web site having the first language-based domain name mapped to a second language-based domain name.

6. The system as recited in claim 5, wherein said search means further includes:
a third search means for searching contents related to a keyword.

7. The system as recited in claim 6, wherein said server computer further includes:
a storage means, coupled to said second search means, for storing a mapping table including first language-based domain names and second language-based domain names.

8. The system as recited in claim 7, wherein said storage means further stores the contents, the category icons and the Web-site icons.

9. The system as recited in claim 8, wherein said server computer further includes:
a first management means, coupled to said storage means, for managing the contents including words, images and links which the user at said client computer can read and interact with; and
a second management means, coupled to said storage means, for managing the category icons contained in the category chapters and the Web-site icons contained in the Web-site link pages.

10. The system as recited in claim 1, wherein the “A” is four.

11. The system as recited in claim 1, wherein the “B” is twenty.

12. The system as recited in claim 1, wherein the “C” is four.

13. The system as recited in claim 1, wherein the “D” is twenty.

14. The system as recited in claim 1, wherein the “B” and the “D” are eighty, respectively.

15. The system as recited in claim 1, wherein the “B” and the “D” are in range between twenty and eighty, respectively.

16. The system as recited in claim 1, wherein one of the Web pages is divided into first and second icon-display spaces.

17. The system as recited in claim 16, wherein the first icon-display space displays an array of the category icons contained in one of the category chapters.

18. The system as recited in claim 16, wherein the second icon-display space displays an array of the Web-site icons contained in one of the Web-site link pages.

19. The system as recited in claim 1, wherein one of the Web pages displays an array of all the category icons contained in the category chapters.

20. The system as recited in claim 1, wherein one of the Web pages displays an array of all the Web-site icons contained in the Web-site link pages.

21. The system as recited in claim 1, wherein one of the Web pages displays a pop-up window containing an array of the Web-site icons when one of the category icons is clicked by the user at said client computer.

22. The system as recited in claim 7, wherein said second search means further includes:
an identifying means for identifying the first language-based domain name mapped to the second language-based domain name from the mapping table.

23. The system as recited in claim 4, wherein said server computer further includes:
a voice recognition means for recognizing a voice input data inputted from a microphone attached to said client computer;
a second storage means for storing user information; and
a user verification means, coupled to said second storage means, for verifying the user from a user input data inputted through a keyboard by comparing the user input data to the user information stored in said second storage means; and disconnecting a connection between said server computer and client computers related to a plurality of users if the users employ the same user input data as each other.

24. The system as recited in claim 23, wherein said server computer further includes:
a third storage means for storing user fingerprints; and
a fingerprint recognition means, coupled to said third storage means, for recognizing user fingerprint outputted from said client computer by comparing the user fingerprint outputted from said client computer to the user fingerprints stored in the third storage means.

25. The system as recited in claim 1, wherein said client computer includes:
a Web browser for connecting said client computer to said server computer through an Internet network.

26. The system as recited in claim 1, wherein each of the Web pages further includes:
an input box having a first or second language-based domain name inputted by the user; and
a search icon being clicked by the user at said client computer so that said server computer searches the target Web site having the first language-based domain name mapped to the second language-based domain name.

27. The system as recited in claim 1, wherein each of the Web pages further includes:
a second input box having a keyword inputted by the user at said client computer.

28. The system as recited in claim 1, wherein said server computer further provides an initial display screen to the user at said client computer when said client computer is connected to said server computer through an Internet network.

29. The system as recited in claim 28, wherein the initial display screen includes:
a first input box having a first language-based domain name inputted by the user;
a second input box having a second language-based domain name inputted by the user;
a third input box having a user identity inputted by the user; and
a fourth input box having a password inputted by the user.

30. The system as recited in claim 26, wherein the first language-based domain name includes an English-based domain name.

31. The system as recited in claim 26, wherein the second language-based domain name includes a Korean-based domain name, a Japanese-based domain name, a Chinese-based domain name, a German-based domain name, a French-based domain name, an Italian-based domain name, a Latin language-based domain name, a Russian-based domain name, a Spanish-based domain name, an Arab language-based domain name, a Portuguese-based domain name, a Dutch-based domain name and a Hindustani-based domain name.

32. The system as recited in claim 1, wherein the category icons are for categories of businesses and services.

33. The system as recited in claim 9, wherein said first management means further updates the contents stored in said storage means at predetermined time periods.

34. The system as recited in claim 9, wherein said second management means further updates the category icons and the Web-site icons stored in said storage means at predetermined time periods.

35. The system as recited in claim 1, wherein the target Web site is connected to said client computer if one of the Web-site icons is clicked by the user at said client computer.

36. The system as recited in claim 1, wherein the category icons are rearranged according to the frequency number of category use at years or months.

37. The system as recited in claim 1, wherein the Web-site icons are rearranged according to the frequency number of Web-site use at years or months.

38. The system as recited in claim 1, wherein colors of the category icons are variable according to the frequency number of category use, and the color of one of the category icons becomes bright if the frequency number of category use with respect to the category icon is many, and the color of one of the category icons becomes dark if the frequency number of category use with respect to the category icon is less.

39. The system as recited in claim 1, wherein colors of the Web-site icons are variable according to the frequency number of Web-site use, and the color of one of the Web-site icons becomes bright if the frequency number of Web-site use with respect to the Web-site icon is many, and the color of one of the Web-site icons becomes dark if the frequency number of Web-site use with respect to the Web-site icon is less.

40. The system as recited in claim 1, wherein one of the Web-site link pages includes hypertext links for searching the target Web site.

41. The system as recited in claim 1, wherein one of the category chapters includes another icon being clicked by the user so that a list of “80” category icons arranged in alphabetic order is displayed.

42. The system as recited in claim 1, wherein one of the category chapters includes another icon being clicked by the user so that a list of “80” category hypertext links arranged in alphabetic order is displayed.

43. The system as recited in claim 1, wherein one of the Web-site link pages includes another icon being clicked by the user so that a list of “80” Web-site icons arranged in alphabetic order is displayed.

44. The system as recited in claim 1, wherein one of the Web-site link pages includes another icon being clicked by the user so that a list of “80” Web-site hypertext links arranged in alphabetic order is displayed.

45. The system as recited in claim 1, wherein one of the category chapters includes another icon being clicked by the user so that a pop-up window displays the category icons arranged from bottom to top according to the frequency number of category use.

46. The system as recited in claim 1, wherein one of the Web-site link pages includes another icon being clicked by the user so that a pop-up window displays the Web-site icons arranged from bottom to top according to the frequency number of Web-site use.

47. The system as recited in claim 1, wherein one of the category chapters includes the category icons related to “SEARCH ENGINE”, “BANK/FINANCE”, “WORLD INTERNET” and “FREE PHONE”.

48. The system as recited in claim 47, wherein one of the Web-site link pages includes the Web-site icons related to “YAHOO! KOREA”, “LYCOS KOREA”, “NAVER”, “HANMIR”, “DREAMWIZ”, “EMPAS”, “SIMMANI”, “DAUM”, “ALTAVISTA”, “MOCHANNI”, “YAHOO.COM”, “LYCOS.COM”, “EXCITE.COM”, “ABOUT.COM”, “ALTAVISTA.COM”, “GO.COM”, “MSN.COM”, “GOOGLE”, “HOTBOT.COM” and “GOHIP.COM”.

49. The system as recited in claim 47, wherein one of the Web-site link pages includes the Web-site icons related to “KYONGNAM BANK”, “KWANGJU BANK”, “KOOKMIN BANK”, “DAEGU BANK”, “PUSAN BANK”, “SEOUL BANK”, “SHINHAN BANK”, “KOREA EXCHANGE BANK”, “JEONBUK BANK”, “KOREA FIRST BANK”, “CHEJU BANK”, “CHOHUNG BANK”, “HOUSING & COMMERCIAL BANK”, “HANA BANK”, “KORAM BANK”, “HANVIT BANK”, “KTB NETWORK”, “LG INSURANCE”, “DONGBU INSURANCE” and “SAMSUNG INSURANCE”.

50. The system as recited in claim 47, wherein one of the Web-site link pages includes the Web-site icons related to “AMERICA”, “JAPAN”, “GERMANY”, “ENGLAND”, “FRANCE”, “AUSTRALIA”, “BRAZIL”, “CHINA”, “DENMARK”, “NETHERLANDS”, “SWITZERLAND”, “ARGENTINA”, “ITALY”, “HONG KONG”, “SWEDEN”, “NEW ZEALAND”, “SOUTH AFRICA”, “AUSTRIA”, “TAIWAN” and “NORWAY”.

51. The system as recited in claim 47, wherein one of the Web-site link pages includes the Web-site icons related to “DIAL PAD KOREA ”, “WOWCALL.COM”, “KOREA TELECOM”, “TELEFREE.CO.KR”, “QPTEL.CO.KR”, “TELCOIN.COM”, “NAZM” and “DIAL PAD U.S.”.

52. A system for searching a target Web site, comprising:
an Internet network;
a client computer, coupled to said Internet network, for displaying at least one target Web page contained in the target Web site, said client computer having a Web browser;
an intermediate server computer, coupled to said Internet network, for providing an Internet portal site having a plurality of Web pages to said client computer in order to search the target Web site targeted by a user at the client computer, the Web pages including:
“A” number of category chapters each containing “B” number of category icons where the “A” and the “B” are positive integers; and
“C” number of Web-site link pages each containing “D” number of Web-site icons linked to one of the “B” number of category icons where the “C” and the “D” are the positive integers; and
a target server computer, coupled to said Internet network, for providing the target Web page contained in the target Web site to said client computer.

53. The system as recited in claim 52, wherein the Web-site icons are arranged according to the frequency number of Web-site use and the category icons are arranged according to the frequency number of category use.

54. The system as recited in claim 52, wherein the Web-site icons are arranged in alphabetic order and the category icons are arranged in alphabetic order.

55. The system as recited in claim 52, wherein said intermediate server computer includes:
a search means for searching the target Web site targeted by a user at the client computer.

56. The system as recited in claim 55, wherein said search means includes:
a first search means for searching the target Web site having a first language-based domain name; and
a second search means for searching the target Web site having the first language-based domain name mapped to a second language-based domain name.

57. The system as recited in claim 56, wherein said search means further includes:
a third search means for searching contents related to a keyword.

58. The system as recited in claim 57, wherein said intermediate server computer further includes:
a storage means, coupled to said second search means, for storing a mapping table including first language-based domain names and second language-based domain names.

59. The system as recited in claim 58, wherein said storage means further stores the contents, the category icons and the Web-site icons.

60. The system as recited in claim 58, wherein said intermediate server computer further includes:
a first management means, coupled to said storage means, for managing the contents including words, images and links which the user at said client computer can read and interact with; and
a second management means, coupled to said storage means, for managing the category icons contained in the category chapters and the Web-site icons contained in the Web-site link pages.

61. The system as recited in claim 52, wherein the “A” is four.

62. The system as recited in claim 52, wherein the “B” is twenty.

63. The system as recited in claim 52, wherein the “C” is four.

64. The system as recited in claim 52, wherein the “D” is twenty.

65. The system as recited in claim 52, wherein the “B” and the “D” are eighty, respectively.

66. The system as recited in claim 52, wherein the “B” and the “D” are in range between twenty and eighty, respectively.

67. The system as recited in claim 52, wherein one of the Web pages is divided into first and second icon-display spaces.

68. The system as recited in claim 67, wherein the first icon-display space displays an array of the category icons contained in one of the category chapters.

69. The system as recited in claim 67, wherein the second icon-display space displays an array of the Web-site icons contained in one of the Web-site link pages.

70. The system as recited in claim 52, wherein one of the Web pages displays an array of all the category icons contained in the category chapters.

71. The system as recited in claim 52, wherein one of the Web pages displays an array of all the Web-site icons contained in the Web-site link pages.

72. The system as recited in claim 52, wherein one of the Web pages displays a pop-up window containing an array of the Web-site icons when one of the category icons is clicked by the user at said client computer.

73. The system as recited in claim 56, wherein said second search means further includes:
an identifying means for identifying the first language-based domain name mapped to a second language-based domain name from the mapping table.

74. The system as recited in claim 55, wherein said intermediate server computer further includes:
a voice recognition means for recognizing a voice input data inputted from a microphone attached to said client computer;
a second storage means for storing user information; and
a user verification means, coupled to said second storage means, for verifying the user from a user input data inputted through a keyboard by comparing the user input data to the user information stored in said second storage means; and disconnecting a connection between said intermediate server computer and client computers related to a plurality of users if the users employ the same user input data as each other.

75. The system as recited in claim 74, wherein said intermediate server computer further includes:
a third storage means for storing user fingerprints; and
a fingerprint recognition means, coupled to said third storage means, for recognizing user fingerprint outputted from said client computer by comparing the user fingerprint outputted from said client computer to the user fingerprints stored in the third storage means.

76. The system as recited in claim 52, wherein each of the Web pages further includes:
an input box having a first or second language-based domain name inputted by the user; and
a search icon being clicked by the user at said client computer so that said intermediate server computer searches the target Web site having the first language-based domain name mapped to the second language-based domain name.

77. The system as recited in claim 52, wherein each of the Web pages further includes:
a second input box having a keyword inputted by the user at said client computer.

78. The system as recited in claim 52, wherein said server computer further provides an initial display screen to the user at said client computer when said client computer is connected to said intermediate server computer through the Internet network.

79. The system as recited in claim 78, wherein the initial display screen includes:
a first input box having a first language-based domain name inputted by the user;
a second input box having a second language-based domain name inputted by the user;
a third input box having a user identity inputted by the user; and
a fourth input box having a password inputted by the user.

80. The system as recited in claim 76, wherein the first language-based domain name includes an English-based domain name.

81. The system as recited in claim 76, wherein the second language-based domain name includes a Korean-based domain name, a Japanese-based domain name, a Chinese-based domain name, a German-based domain name, a French-based domain name, an Italian-based domain name, a Latin language-based domain name, a Russian-based domain name, a Spanish-based domain name, an Arab language-based domain name, a Portuguese-based domain name, a Dutch-based domain name and a Hindustani-based domain name.

82. The system as recited in claim 52, wherein the category icons are for categories of businesses and services.

83. The system as recited in claim 60, wherein said first management means further updates the contents stored in said storage means at predetermined time periods.

84. The system as recited in claim 60, wherein said second management means further updates the category icons and the Web-site icons stored in said storage means at predetermined time periods.

85. The system as recited in claim 52, wherein the target Web site is connected to said client computer if one of the Web-site icons is clicked by the user at said client computer.

86. The system as recited in claim 52, wherein the category icons are rearranged according to the frequency number of category use at years or months.

87. The system as recited in claim 52, wherein the Web-site icons are rearranged according to the frequency number of Web-site use at years or months.

88. The system as recited in claim 52, wherein colors of the category icons are variable according to the frequency number of category use, and the color of one of the category icons becomes bright if the frequency number of category use with respect to the category icon is many, and the color of one of the category icons becomes dark if the frequency number of category use with respect to the category icon is less.

89. The system as recited in claim 52, wherein colors of the Web-site icons are variable according to the frequency number of Web-site use, and the color of one of the Web-site icons becomes bright if the frequency number of Web-site use with respect to the Web-site icon is many, and the color of one of the Web-site icons becomes dark if the frequency number of Web-site use with respect to the Web-site icon is less.

90. The system as recited in claim 52, wherein one of the Web-site link pages includes hypertext links for searching the target Web site.

91. The system as recited in claim 52, wherein one of the category chapters includes another icon being clicked by the user so that a list of “80” category icons arranged in alphabetic order is displayed.

92. The system as recited in claim 52, wherein one of the category chapters includes another icon being clicked by the user so that a list of “80” category hypertext links arranged in alphabetic order is displayed.

93. The system as recited in claim 52, wherein one of the Web-site link pages includes another icon being clicked by the user so that a list of “80” Web-site icons arranged in alphabetic order is displayed.

94. The system as recited in claim 52, wherein one of the Web-site link pages includes another icon being clicked by the user so that a list of “80” Web-site hypertext links arranged in alphabetic order is displayed.

95. The system as recited in claim 52, wherein one of the category chapters includes another icon being clicked by the user so that a pop-up window displays the category icons arranged from bottom to top according to the frequency number of category use.

96. The system as recited in claim 52, wherein one of the Web-site link pages includes another icon being clicked by the user so that a pop-up window displays the Web-site icons arranged from bottom to top according to the frequency number of Web-site use.

97. The system as recited in claim 52, wherein one of the category chapters includes the category icons related to “SEARCH ENGINE”, “BANK/FINANCE”, “WORLD INTERNET” and “FREE PHONE”.

98. The system as recited in claim 97, wherein one of the Web-site link pages includes the Web-site icons related to “YAHOO! KOREA”, “LYCOS KOREA”, “NAVER”, “HANMIR”, “DREAMWIZ”, “EMPAS”, “SIMMANI”, “DAUM”, “ALTAVISTA”, “MOCHANNI”, “YAHOO.COM”, “LYCOS.COM”, “EXCITE.COM”, “ABOUT.COM”, “ALTAVISTA.COM”, “GO.COM”, “MSN.COM”, “GOOGLE”, “HOTBOT.COM” and “GOHIP.COM”.

99. The system as recited in claim 97, wherein one of the Web-site link pages includes the Web-site icons related to “KYONGNAM BANK”, “KWANGJU BANK”, “KOOKMIN BANK”, “DAEGU BANK”, “PUSAN BANK”, “SEOUL BANK”, “SHINHAN BANK”, “KOREA EXCHANGE BANK”, “JEONBUK BANK”, “KOREA FIRST BANK”, “CHEJU BANK”, “CHOHUNG BANK”, “HOUSING & COMMERCIAL BANK”, “HANA BANK”, “KORAM BANK”, “HANVIT BANK”, “KTB NETWORK”, “LG INSURANCE”, “DONGBU INSURANCE” and “SAMSUNG INSURANCE”.

100. The system as recited in claim 97, wherein one of the Web-site link pages includes the Web-site icons related to “AMERICA”, “JAPAN”, “GERMANY”, “ENGLAND”, “FRANCE”, “AUSTRALIA”, “BRAZIL”, “CHINA”, “DENMARK”, “NETHERLANDS”, “SWITZERLAND”, “ARGENTINA”, “ITALY”, “HONG KONG”, “SWEDEN”, “NEW ZEALAND”, “SOUTH AFRICA”, “AUSTRIA”, “TAIWAN” and “NORWAY”.

101. The system as recited in claim 97, wherein one of the Web-site link pages includes the Web-site icons related to “DIAL PAD KOREA”, “WOWCALL.COM”, “KOREA TELECOM”, “TELEFREE.CO.KR”, “QPTEL.CO.KR”, “TELCOIN.COM”, “NAZM” and “DIAL PAD U.S.”.

102. A method for searching a target Web site, comprising the steps of:
a) providing an Internet portal site having a plurality of Web pages to a client computer in order to search the target Web site targeted by a user at the client computer, the Web pages including:
“A” number of category chapters each containing “B” number of category icons where the “A” and the “B” are positive integers; and
“C” number of Web-site link pages each containing “D” number of Web-site icons linked to one of the “B” number of category icons where the “C” and the “D” are the positive integers;
b) providing at least one target Web page contained in the target Web site to the client computer; and
c) displaying the target Web page contained in the target Web site.

103. The method as recited in claim 102, wherein the Web-site icons are arranged according to the frequency number of Web-site use and the category icons are arranged according to the frequency number of category use.

104. The method as recited in claim 102, wherein the Web-site icons are arranged in alphabetic order and the category icons are arranged in alphabetic order.

105. The method as recited in claim 102, wherein said step a) further includes the step of:
a1) searching the target Web site targeted by the user at the client computer.

106. The method as recited in claim 105, wherein said step a1) further includes the steps of:
a1-a) searching the target Web site having a first language-based domain name; and
a1-b) searching the target Web site having the first language-based domain name mapped to a second language-based domain name.

107. The method as recited in claim 106, wherein said step a1) further includes the step of:
a1-c) searching contents related to a keyword.

108. The method as recited in claim 106, wherein said step a1) further includes the step of:
a1-d) storing a mapping table including first language-based domnain names and second language-based domain names.

109. The method as recited in claim 107, wherein said step a1) further includes the step of:
a1-e) storing the contents, the category icons and the Web-site icons.

110. The method as recited in claim 102, wherein the “A” is four.

111. The method as recited in claim 102, wherein the “B” is twenty.

112. The method as recited in claim 102, wherein the “C” is four.

113. The method as recited in claim 102, wherein the “D” is twenty.

114. The method as recited in claim 102, wherein the “B” and the “D” are eighty, respectively.

115. The method as recited in claim 102, wherein the “B” and the “D” are in range between twenty and eighty, respectively.

116. The method as recited in claim 102, wherein one of the Web pages is divided into first and second icon-display spaces.

117. The method as recited in claim 116, wherein the first icon-display space displays an array of the category icons contained in one of the category chapters.

118. The method as recited in claim 116, wherein the second icon-display space displays an array of the Web-site icons contained in one of the Web-site link pages.

119. The method as recited in claim 102, wherein one of the Web pages displays an array of all the category icons contained in the category chapters.

120. The method as recited in claim 102, wherein one of the Web pages displays an array of all the Web-site icons contained in the Web-site link pages.

121. The method as recited in claim 102, wherein one of the Web pages displays a pop-up window containing an array of the Web-site icons when one of the category icons is clicked by the user at the client computer.

122. The method as recited in claim 108, wherein said step a1) further includes the step of:
a1-f) identifying the first language-based domain name mapped to the second language-based domain name from the mapping table.

123. The method as recited in claim 102, wherein said step a) further includes the step of:
a2) recognizing a voice input data inputted from a microphone attached to said client computer.

124. The method as recited in claim 102, wherein said step a) further includes the steps of:
a3) storing user information; and
a4) verifying the user from a user input data inputted through a keyboard by comparing the user input data to the user information stored; and disconnecting a connection between an intermediate server computer and client computers related to a plurality of users if the users employ the same user input data as each other.

125. The method as recited in claim 105, wherein said step a) further includes the steps of:
a5) storing user fingerprints; and
a6) recognizing user fingerprint outputted from the client computer by comparing the user fingerprint outputted from the client computer to the user fingerprints stored.

126. The method as recited in claim 102, wherein each of the Web pages further includes:
an input box having a first or second language-based domain name inputted by the user; and
a search icon being clicked by the user at the client computer so that an intermediate server computer searches the target Web site having the first language-based domain name mapped to the second language-based domain name.

127. The method as recited in claim 102, wherein each of the Web pages further includes:
a second input box having a keyword inputted by the user at said client computer.

128. The method as recited in claim 102, wherein said step a) further includes the step of:
a7) providing an initial display screen to the user at the client computer when the client computer is connected to an intermediate server computer through an Internet network.

129. The method as recited in claim 128, wherein the initial display screen includes:
a first input box having a first language-based domain name inputted by the user;
a second input box having a second language-based domain name inputted by the user;
a third input box having a user identity inputted by the user; and
a fourth input box having a password inputted by the user.

130. The method as recited in claim 126, wherein the first language-based domain name includes an English-based domain name.

131. The method as recited in claim 126, wherein the second language-based domain name includes a Korean-based domain name, a Japanese-based domain name, a Chinese-based domain name, a German-based domain name, a French-based domain name, an Italian-based domain name, a Latin language-based domain name, a Russian-based domain name, a Spanish-based domain name, an Arab language-based domain name, a Portuguese-based domain name, a Dutch-based domain name and a Hindustani-based domain name.

132. The method as recited in claim 102, wherein the category icons are for categories of businesses and services.

133. The method as recited in claim 102, wherein the category icons are rearranged according to the frequency number of category use at years or months.

134. The method as recited in claim 102, wherein the Web-site icons are rearranged according to the frequency number of Web-site use at years or months.

135. The method as recited in claim 102, wherein colors of the category icons are variable according to the frequency number of category use, and the color of one of the category icons becomes bright if the frequency number of category use with respect to the category icon is many, and the color of one of the category icons becomes dark if the frequency number of category use with respect to the category icon is less.

136. The method as recited in claim 102, wherein colors of the Web-site icons are variable according to the frequency number of Web-site use, and the color of one of the Web-site icons becomes bright if the frequency number of Web-site use with respect to the Web-site icon is many, and the color of one of the Web-site icons becomes dark if the frequency number of Web-site use with respect to the Web-site icon is less.

137. The method as recited in claim 102, wherein one of the Web-site link pages includes hypertext links for searching the target Web site.

138. The method as recited in claim 102, wherein one of the category chapters includes another icon being clicked by the user so that a list of “80” category icons arranged in alphabetic order is displayed.

139. The method as recited in claim 102, wherein one of the category chapters includes another icon being clicked by the user so that a list of “80” category hypertext links arranged in alphabetic order is displayed.

140. The method as recited in claim 102, wherein one of the Web-site link pages includes another icon being clicked by the user so that a list of “80” Web-site icons arranged in alphabetic order is displayed.

141. The method as recited in claim 102, wherein one of the Web-site link pages includes another icon being clicked by the user so that a list of “80” Web-site hypertext links arranged in alphabetic order is displayed.

142. The method as recited in claim 102, wherein one of the category chapters includes another icon being clicked by the user so that a pop-up window displays the category icons arranged from bottom to top according to the frequency number of category use.

143. The method as recited in claim 102, wherein one of the Web-site link pages includes another icon being clicked by the user so that a pop-up window displays the Web-site icons arranged from bottom to top according to the frequency number of Web-site use.

144. The method as recited in claim 102, wherein one of the category chapters includes the category icons related to “SEARCH ENGINE”, “BANK/FINANCE”, “WORLD INTERNET” and “FREE PHONE”.

145. The method as recited in claim 144, wherein one of the Web-site link pages includes the Web-site icons related to “YAHOO! KOREA”, “LYCOS KOREA”, “NAVER”, “HANMIR”, “DREAMWIZ”, “EMPAS”, “SIMMANI”, “DAUM”, “ALTAVISTA”, “MOCHANNI”, “YAHOO.COM”, “LYCOS.COM”, “EXCITE.COM”, “ABOUT.COM”, “ALTAVISTA.COM”, “GO.COM”, “MSN.COM”, “GOOGLE”, “HOTBOT.COM” and “GOHIP.COM”.

146. The method as recited in claim 144, wherein one of the Web-site link pages includes the Web-site icons related to “KYONGNAM BANK”, “KWANGJU BANK”, “KOOKMIN BANK”, “DAEGU BANK”, “PUSAN BANK”, “SEOUL BANK”, “SHINHAN BANK”, “KOREA EXCHANGE BANK”, “JEONBUK BANK”, “KOREA FIRST BANK”, “CHEJU BANK”, “CHOHUNG BANK”, “HOUSING & COMMERCIAL BANK”, “HANA BANK”, “KORAM BANK”, “HANVIT BANK”, “KTB NETWORK”, “LG INSURANCE”, “DONGBU INSURANCE” and “SAMSUNG INSURANCE”.

147. The method as recited in claim 144, wherein one of the Web-site link pages includes the Web-site icons related to “AMERICA”, “JAPAN”, “GERMANY”, “ENGLAND”, “FRANCE”, “AUSTRALIA”, “BRAZIL”, “CHINA”, “DENMARK”, “NETHERLANDS”, “SWITZERLAND”, “ARGENTINA”, “ITALY”, “HONG KONG”, “SWEDEN”, “NEW ZEALAND”, “SOUTH AFRICA”, “AUSTRIA”, “TAIWAN” and “NORWAY”.

148. The method as recited in claim 144, wherein one of the Web-site link pages includes the Web-site icons related to “DIAL PAD KOREA”, “WOWCALL.COM”, “KOREA TELECOM”, “TELEFREE.CO.KR”, “QPTEL.CO.KR”, “TELCOIN.COM”, “NAZM” and “DIAL PAD U.S.”.

149. A computer-readable medium storing program instructions, the program instructions disposed on a computer to perform a method for searching a target Web site, the method comprising the steps of:
a) providing an Internet portal site having a plurality of Web pages to a client computer in order to search the target Web site targeted by a user at the client computer, the Web pages including:
“A” number of category chapters each containing “B” number of category icons where the “A” and the “B” are positive integers; and
“C” number of Web-site link pages each containing “D” number of Web-site icons linked to one of the “B” number of category icons where the “C” and the “D” are the positive integers;
b) providing at least one target Web page contained in the target Web site to the client computer; and
c) displaying the target Web page contained in the target Web site.

150. The computer-readable medium as recited in claim 149, wherein the Web-site icons are arranged according to the frequency number of Web-site use and the category icons are arranged according to the frequency number of category use.

151. The computer-readable medium as recited in claim 149, wherein the Web-site icons are arranged in alphabetic order and the category icons are arranged in alphabetic order.

152. The computer-readable medium as recited in claim 149, wherein the “A” is four.

153. The computer-readable medium as recited in claim 149, wherein the “B” is twenty.

154. The computer-readable medium as recited in claim 149, wherein the “C” is four.

155. The computer-readable medium as recited in claim 149, wherein the “D” is twenty.

156. The computer-readable medium as recited in claim 149, wherein the “B” and the “D” are eighty, respectively.

157. The computer-readable medium as recited in claim 149, wherein the “B” and the “D” are in range between twenty and eighty, respectively.

158. The computer-readable medium as recited in claim 149, wherein one of the Web pages is divided into first and second icon-display spaces.

159. The computer-readable medium as recited in claim 158, wherein the first icon-display space displays an array of the category icons contained in one of the category chapters.

160. The computer-readable medium as recited in claim 158, wherein the second icon-display space displays an array of the Web-site icons contained in one of the Web-site link pages.

161. The computer-readable medium as recited in claim 149, wherein one of the Web pages displays an array of all the category icons contained in the category chapters.

162. The computer-readable medium as recited in claim 149, wherein one of the Web pages displays an array of all the Web-site icons contained in the Web-site link pages.

163. The computer-readable medium as recited in claim 149, wherein one of the Web pages displays a pop-up window containing an array of the Web-site icons when one of the category icons is clicked by the user at the client computer.

164. The computer-readable medium as recited in claim 149, wherein the category icons are rearranged according to the frequency number of category use at years or months.

165. The computer-readable medium as recited in claim 149, wherein the Web-site icons are rearranged according to the frequency number of Web-site use at years or months.

166. The computer-readable medium as recited in claim 149, wherein colors of the category icons are variable according to the frequency number of category use, and the color of one of the category icons becomes bright if the frequency number of category use with respect to the category icon is many, and the color of one of the category icons becomes dark if the frequency number of category use with respect to the category icon is less.

167. The computer-readable medium as recited in claim 149, wherein colors of the Web-site icons are variable according to the frequency number of Web-site use, and the color of one of the Web-site icons becomes bright if the frequency number of Web-site use with respect to the Web-site icon is many, and the color of one of the Web-site icons becomes dark if the frequency number of Web-site use with respect to the Web-site icon is less.

168. The computer-readable medium as recited in claim 149, wherein one of the category chapters includes another icon being clicked by the user so that a list of “80”category icons arranged in alphabetic order is displayed.

169. The computer-readable medium as recited in claim 149, wherein one of the category chapters includes another icon being clicked by the user so that a list of “80”category hypertext links arranged in alphabetic order is displayed.

170. The computer-readable medium as recited in claim 149, wherein one of the Web-site link pages includes another icon being clicked by the user so that a list of “80” Web-site icons arranged in alphabetic order is displayed.

171. The computer-readable medium as recited in claim 149, wherein one of the Web-site link pages includes another icon being clicked by the user so that a list of “80” Web-site hypertext links arranged in alphabetic order is displayed.

172. The computer-readable medium as recited in claim 149, wherein one of the category chapters includes another icon being clicked by the user so that a pop-up window displays the category icons arranged from bottom to top according to the frequency number of category use.

173. The computer-readable medium as recited in claim 149, wherein one of the Web-site link pages includes another icon being clicked by the user so that a pop-up window displays the Web-site icons arranged from bottom to top according to the frequency number of Web-site use.
